(19) United States
(12) Patent Application Publication
(10) Pub. No.: US 2023/0260418 A1
(43) Pub. Date: Aug. 17, 2023

(54) VOCABULARY SIZE ESTIMATION APPARATUS, VOCABULARY SIZE ESTIMATION METHOD, AND PROGRAM

(71) Applicant: NIPPON TELEGRAPH AND TELEPHONE CORPORATION, Tokyo (JP)

(72) Inventors: Sanae FUJITA, Tokyo (JP); Takashi HATTORI, Tokyo (JP); Tessei KOBAYASHI, Tokyo (JP)

(73) Assignee: NIPPON TELEGRAPH AND TELEPHONE CORPORATION, Tokyo (JP)

(21) Appl. No.: 18/012,159

(22) PCT Filed: Jun. 22, 2020
(86) PCT No.: PCT/JP2020/024345

§ 371 Date: Dec. 21, 2022

(51) Int. Cl. G09B 7/06; G06F 40/279; G06F 40/253; G09B 19/06; G06F 16/33

(52) U.S. Cl. CPC G09B 7/06; G06F 40/279; G06F 40/253; G09B 19/06; G06F 16/3346

(57) ABSTRACT

An apparatus selects a plurality of test words from a plurality of words, presents the test words to users, receives answers regarding knowledge of the test words of the users, and obtains a model representing a relationship between values based on probabilities that the users answer that the users know the words and values based on vocabulary sizes of the users when the users answer that the users know the words, by using the test words, estimated vocabulary sizes of people who know the test words, and the answers regarding the knowledge of the test words. Here, the estimated vocabulary sizes are obtained based on frequencies of appearance of the words in a corpus and parts of speech of the words.

### TECHNICAL FIELD

The present invention relates to a technique for estimating a vocabulary size.

### BACKGROUND ART

The total number of words a person knows is called a vocabulary size of the person. A vocabulary size estimation test is a test for accurately estimating the vocabulary size in a short time (for example, see NPL 1 and the like). The outline of the estimation procedure is illustrated below.

(1) Select test words from a word list of a word familiarity DB (database) in order of familiarity at substantially regular intervals. The familiarities of the test words do not necessarily have to be at regular intervals, but may be at substantially regular intervals. That is, the numerical values of the familiarity of the test words may be coarse or dense. Note that the familiarity (word familiarity) is a numerical value of the familiarity of a word. The familiarity indicates that the higher the familiarity of a word is, the more familiar the word is.
(2) Present the test words to users and ask the users to answer whether or not the users know the words.
(3) Generate a logistic curve that fits the answers to the test words. Here, in this logistic curve, the total number of words having a higher familiarity than each test word in the word familiarity DB is set as an independent variable x, and a probability that the users answer that the users know each word is set as a dependent variable y.
(4) Calculate a value of x corresponding to y=0.5 in the logistic curve as the estimated vocabulary size. Note that the estimated vocabulary size refers to a value estimated as a vocabulary size of a user.

In this method, by using the word familiarity DB, it is possible to accurately estimate the vocabulary size of the user by simply testing whether or not the selected test words are known.

### CITATION LIST

### Non Patent Literature

NPL 1: Tetsuo Kobayashi, Shigeaki Amano, Nobuo Masataka, “Current Situation and Whereabouts of Mobile Society”, 2007, NTT Publishing, p127-128.

### SUMMARY OF THE INVENTION

### Technical Problem

In a conventional method, it is assumed that the familiarities of words are known, and the vocabulary size is estimated by assuming that a person who knows a word with a certain familiarity knows all the words with higher familiarities.

However, there is no large-scale data of the familiarities of words directed for non-native languages. For example, in a case where the users are Japanese people, a language such as English other than Japanese is a non-native language. There are familiarity data of tens of thousands to hundreds of thousands of Japanese words for Japanese people, but there is no large-scale data of familiarities of English words for Japanese people. There are data on familiarity of English surveyed for native English speakers. However, the familiarities of English words will not necessarily match between native English speakers and Japanese people who are non-native English speakers.

As described above, it is conceivable to estimate the familiarities of words by using the frequencies of appearance of the words in a corpus, for example, in a case where there is no large-scale data of the word familiarities or in a case where it does exist but cannot be used. In a case where vocabulary size estimation is performed by ranking words in the order of the frequency of appearance in this way, it is desirable that the order of the frequencies of appearance of words and the order of the familiarities of words match as much as possible. However, while some words do not conjugate such as nouns, other words conjugate such as verbs. For the words that conjugate, it may not be obvious how to count the frequencies of appearance, depending on whether words changed by conjugation are regarded as the same word or different words. There may be differences in the tendency of appearance in a corpus depending on the part of speech, such as the number of different words in nouns is greater than that in verbs and the relative frequency of nouns is lower. Thus, in a case of performing the vocabulary size estimation by ranking words in the order of the frequency of appearance, it is difficult to treat the words of all parts of speech with the same criteria.

Thus, with the conventional method, it is not possible to estimate the vocabulary size of a non-native language of the user with high accuracy. The present invention has been made in view of such a point, and an object of the present invention is to perform the vocabulary size accuracy based on the frequency of appearance with high accuracy.

### Means for Solving the Problem

An apparatus according to the present invention includes a question generation unit that selects a plurality of test words from a plurality of words, a presentation unit that presents the plurality of test words to a user, an answer reception unit that receives an answer regarding knowledge of the plurality of test words of the user, and a vocabulary size estimation unit that uses the plurality of test words, estimated vocabulary sizes of persons who know the plurality of test words, and the answer regarding the knowledge of the plurality of test words to obtain a model representing a relationship between a value based on a probability that the user answers that the user knows the plurality of words and a value based on a vocabulary size of the user when the user answers that the user knows the plurality of words. Here, the estimated vocabulary sizes are obtained based on frequencies of appearance of the plurality of words in a corpus and parts of speech of the plurality of words.

### Effects of the Invention

In the present invention, it is possible to perform the vocabulary size estimation based on the frequency of appearance with high accuracy.

### BRIEF DESCRIPTION OF DRAWINGS

FIG. 1 is a block diagram illustrating a functional configuration of a vocabulary size estimation apparatus according to an embodiment.

FIG. 2A is a histogram illustrating a relationship between familiarity of each word and the number of words of the familiarity of the word. FIG. 2B is a histogram illustrating a relationship between the familiarity of each word and the estimated vocabulary sizes of people who know the corresponding word.

FIG. 3A is a graph illustrating a logistic regression model representing a relationship between the probability that a user answers that the user knows words and the vocabulary size estimated by a conventional method. FIG. 3B is a graph illustrating a logistic regression model representing a relationship between the probability that a user answers that the user knows words and the vocabulary size estimated by a method according to the embodiment.

FIG. 4A is a graph illustrating a logistic regression model representing a relationship between the probability that a user answers that the user knows words and the vocabulary size estimated by a conventional method. FIG. 4B is a graph illustrating a logistic regression model representing a relationship between the probability that a user answers that the user knows words and the vocabulary size estimated by the method according to the embodiment.

FIG. 5 is a diagram illustrating a screen presented by a presentation unit.

FIG. 6 is a diagram illustrating a screen presented by the presentation unit.

FIG. 7 is a diagram illustrating a screen presented by the presentation unit.

FIG. 8 is a diagram illustrating a screen presented by the presentation unit.

FIG. 9A is a graph illustrating a logistic regression model representing a relationship between the probability that a user answers that the user knows a word and the vocabulary size estimated by a conventional method in a case where the test is performed without separating the words by part of speech. FIG. 9B is a graph illustrating a logistic regression model representing a relationship between the probability that a user answers that the user knows a word and the vocabulary size estimated by a conventional method in a case where the test is performed for each part of speech.

FIGS. 10A and 10B are graphs illustrating a logistic regression model representing a relationship between the probability that a user answers that the user knows a word and the vocabulary size estimated by the conventional method when the test is performed for each part of speech.

FIGS. 11A and 11B are diagrams illustrating a vocabulary acquisition curve for estimating the vocabulary acquisition ratio in each grade.

FIGS. 12A and 12B are diagrams illustrating a vocabulary acquisition curve for estimating the vocabulary acquisition ratio in each grade.

FIG. 13 is a block diagram illustrating a hardware configuration of the vocabulary size estimation apparatus according to the embodiment.

### DESCRIPTION OF EMBODIMENTS

Hereinafter, embodiments of the present invention will be described with reference to the drawings.

### First Embodiment

First, a first embodiment of the present invention will be described.

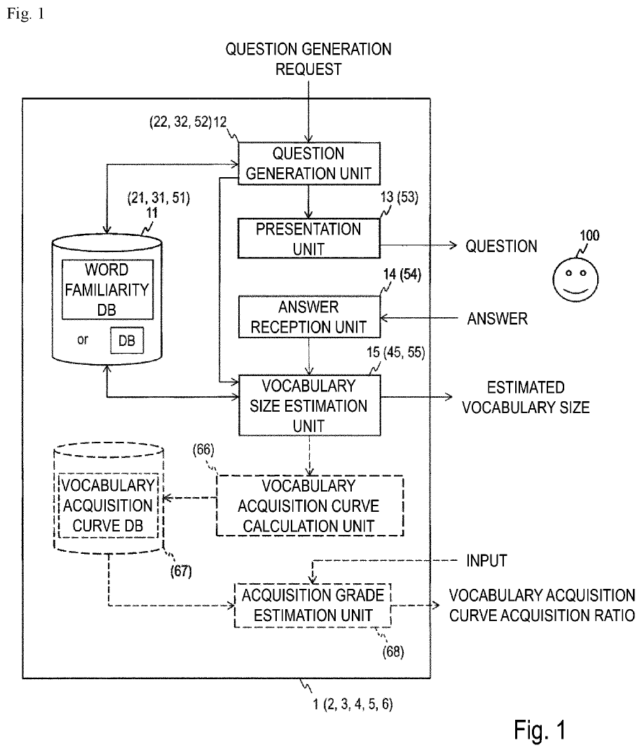

As illustrated in FIG. 1, a vocabulary size estimation apparatus 1 according to the present embodiment includes a storage unit 11, a question generation unit 12, a presentation unit 13, an answer reception unit 14, and a vocabulary size estimation unit 15.

### Storage Unit 11

In the storage unit 11, a familiarity database (DB) is stored in advance. The word familiarity DB is a database that stores a set of M words (a plurality of words) and a predetermined familiarity (word familiarity) for each of the words. According to this, the M words in the word familiarity DB are ranked based on familiarity (for example, in a familiarity order). M is an integer of 2 or greater representing the number of words included in the word familiarity DB. The value of M is not limited, but for example, M is preferably 70000 or greater. It is said that the vocabulary size of Japanese adults is about 40000 to 50000, so it is possible to cover most people's vocabulary including individual differences if M is about 70000. However, an upper limit of the estimated vocabulary size is the number of words included in the word familiarity DB referenced. Thus, in a case of performing a vocabulary estimation for a person having a larger vocabulary size as an outlier, it is desirable to increase the value of M. The familiarity (word familiarity) is a numerical value of the familiarity of a word (for example, see NPL 1 and the like). The higher the familiarity of a word is, the more familiar the word is. In the present embodiment, the larger the numerical value representing the familiarity is, the higher the familiarity is. However, the present invention is not limited to this. The storage unit 11 inputs a read request from the question generation unit 12 and the vocabulary size estimation unit 15, and outputs words corresponding to the request and the familiarities of the words.

### Question Generation Unit 12

Input: Question generation request from user or system

Output: N test words used for vocabulary size estimation test

When the question generation unit 12 receives the question generation request from a user or a system, the question generation unit 12 selects a plurality of test words w(1), . . . , w(N) to be used in the vocabulary size estimation test from a plurality of ordered words included in the word familiarity DB of the storage unit 11, and outputs the selected test words. Here, for example, the question generation unit 12 selects the N words at substantially regular intervals in the order of the familiarity for all the words included in the word familiarity DB of the storage unit 11, and outputs the selected N words as the test words w(1), . . . , w(N). The familiarities of the test words w(1), . . . , w(N) is not necessarily at a regular interval, but may be at substantially regular intervals. That is, the numerical values of the familiarities of the series of test words w(1), . . . , w(N) may be coarse or dense. The order of the test words w(1), . . . , w(N) output from the question generation unit 12 is not limited, but the question generation unit 12 outputs the test words w(1), . . . , w(N), for example, in descending order of familiarity. The number N of the test words may be specified by the question generation request or may be predetermined. The value of N is not limited, but for example, about 50≤N≤100 is desirable. It is desirable that N≥25 for adequate estimation. The larger N is, the more accurate the estimation is possible to be, but the load on the user (subject) is higher (step S12). In order to reduce the load on the user and improve the accuracy, for example, a test of 50 words may be performed a plurality of times (for example, three times), and the vocabulary size may be estimated for each test, or the answers for the plurality of times may be re-estimated collectively. In this case, because the number of test words for each time can be reduced, and the load on the user is smaller, and if the results can be seen for each test, the answering motivation of the user can be maintained. The estimation accuracy can be improved by performing the final vocabulary size estimation by combining words from the plurality of tests.

### Presentation Unit 13

Input: N test words

Output: Instruction sentences and N test words

The N test words w(1), . . . , w(N) output from the question generation unit 12 are input to the presentation unit 13. The presentation unit 13 presents the test words w(1), . . . , w(N) to the user 100 (subject) according to a preset display format. For example, the presentation unit 13 presents to the user 100 predetermined instruction sentences prompting the input of answers regarding the knowledge of the test words of the user 100 and N test words w(1), . . . , w(N) in a format for the vocabulary size estimation test according to the preset display format. This presentation format is not limited, and these pieces of information may be presented as visual information such as text or images, auditory information such as voice, or tactile information such as braille. For example, the presentation unit 13 is a display screen of a terminal device such as a personal computer (PC), a tablet, or a smartphone, and the instruction sentences and the test words may be electronically displayed. Alternatively, the presentation unit 13 may be a printing device, and the instruction sentences and the test words may be output by being printed on paper or the like. Alternatively, the presentation unit 13 may be a speaker of the terminal device, and the instruction sentences and the test words may be output by voice. Alternatively, the presentation unit 13 may be a braille display and present the braille of the instruction sentences and the test words. The answers regarding the knowledge of the test words of the user 100 may represent either “I know” or “I don't know” the test words (answers that the user knows or does not know test words of each rank), or may represent any of three or more choices including “I know” and “I don't know”. Examples of choices other than “I know” and “I don't know” include “I'm not confident (whether I know)” or “I know the word, but I don't know the meaning”. However, in some cases, the accuracy of vocabulary size estimation does not improve as compared with the case where either “I know” or “I don't know” is answered even if the user 100 is asked to answer from three or more choices including “I know” and “I don't know”. For example, in a case where the user 100 is asked to select an answer from the three choices of “I know”, “I don't know”, and “I'm not confident”, whether or not “I'm not confident” is selected depends on the personality of the user 100. In such a case, the accuracy of vocabulary size estimation does not improve even if the number of choices is increased. Thus, it is usually preferable to ask the user 100 to answer the test words from either “I know” or “I don't know”. In the following, an example of asking the user 100 to answer the test words from either “I know” or “I don't know” will be described. For example, the test words are presented in descending order of familiarity, but the presentation order is not limited to this, and the test words may be presented in a random order (step S13). Note that a set of users 100 of the vocabulary size estimation apparatus 1 will be referred to as a subject set. The subject set may be a set of users 100 with specific attributes (for example, generation, gender, occupation, and the like), or may be a set of users 100 with arbitrary attributes (a set in which the attributes of constituent members are not restricted).

### Answer Reception Unit 14

Input: Answers regarding the knowledge of the test words of the user

Output: Answers regarding the knowledge of the test words of the user

The user 100 presented with the instruction sentences and the test words inputs the answers regarding the knowledge of the test words of the user 100 to the answer reception unit 14. For example, the answer reception unit 14 is a touch panel of a terminal device such as a PC, a tablet, or a smartphone, and the user 100 inputs the answers to the touch panel. The answer reception unit 14 may be a microphone of the terminal device, and in this case, the user 100 inputs the answers to the microphone by voice. The answer reception unit 14 receives the input answers regarding the knowledge of the test words (for example, answers that the user knows test words, or answers that the user does not know test words), and outputs the answers as electronic data. The answer reception unit 14 may output answers for respective test words, may output answers collectively for one test, or may output answers collectively for a plurality of tests (step S14).

### Vocabulary Size Estimation Unit 15

Input: Answers regarding the knowledge of the test words of the user

Output: Estimated vocabulary size of the user

The answers regarding the knowledge of the test words of the user 100 output from the answer reception unit 14 are input to the vocabulary size estimation unit 15. In a case where the user 100 answers that “I know” for each test word w(n) (where, n=1, . . . , N), the vocabulary size estimation unit 15 counts up the number of people who know the test word w(n). The vocabulary size estimation unit 15 stores the number of people who know the test word w(n) in association with the test word in the word familiarity DB of the storage unit 11. A similar process is performed for the answers of the plurality of users 100 (subjects) belonging to the subject set. As a result, the number of people who know each test word w(n) is associated with the test word in the word familiarity DB. Here, a numerical value representing the “familiarity” of a subject belonging to the subject set for each test word w(n) based on the number or the ratio of people who answered that they knew the test word w(n) is referred to as the familiarity within the subjects a(n). The familiarity within the subjects a(n) of the test word w(n) is a value (for example, a function value) based on the number or the ratio of people who answered that they knew the test word w(n). For example, the familiarity within the subjects a(n) of the test word w(n) may be the number of people itself who answered that they knew the test word w(n), may be a non-monotonically decreasing function value (for example, a monotonically increasing function value) of the number of people who answered that they knew the test word w(n), may be the ratio of the number of people who answered that they knew the test word w(n) to the total number of the users 100 who made the answers, may be the ratio of the number of people who answered that they knew the test word to all the members of the subject set, or may be a non-monotonically decreasing function value (for example, a monotonically increasing function value) of any of these ratios. Note that the initial value of each familiarity within the subjects a(n) may be, for example, the familiarity itself of the test word w(n), or may be another fixed value (step S151).

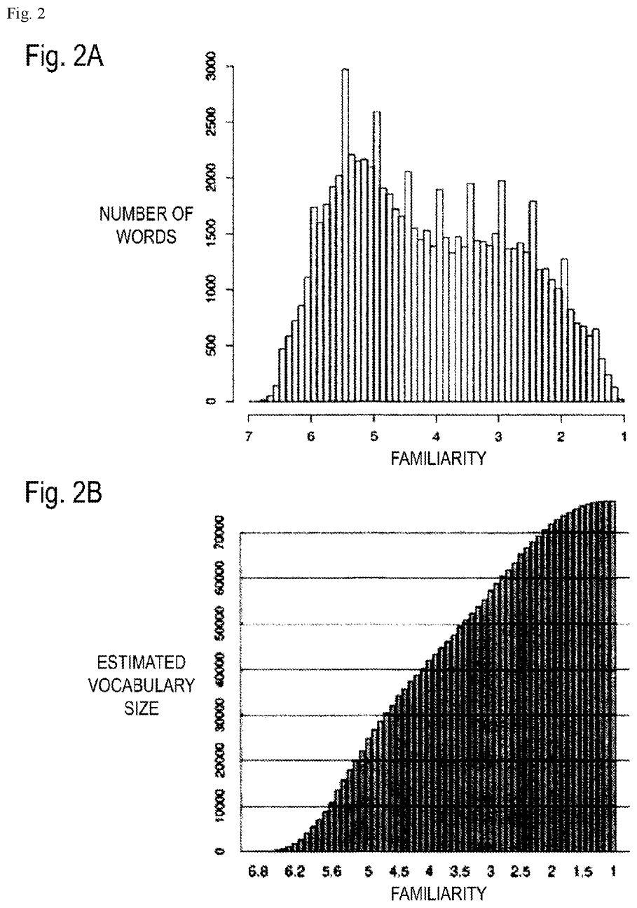

The vocabulary size estimation unit 15 further receives an input of test words w(1), . . . , w(N) output from the question generation unit 12. The vocabulary size estimation unit 15 uses the word familiarity DB stored in the storage unit 11 to obtain a potential vocabulary size x(n) of each test word w(n). As described above, the word familiarity DB stores the familiarity of each word. The vocabulary size estimation unit 15 obtains the potential vocabulary size x(n) corresponding to each test word w(n) based on the familiarity predetermined for the word in the word familiarity DB. Note that the “potential vocabulary size” corresponding to the test word is the number (vocabulary size) of all words (including words other than the test word) that the subject is supposed to know in a case where the subject knows the test word. For example, the vocabulary size estimation unit 15 obtains the total number of words having higher familiarities than each test word w(n) in the word familiarity DB as the potential vocabulary size x(n) of a person who knows the test word. This is based on the assumption that a person who knows a test word knows all the words with higher familiarities than the test word. That is, when the number of words of each familiarity in the word familiarity DB is counted, a histogram representing the relationship between the familiarity of each word in the word familiarity DB and the number of words of the familiarity is obtained as illustrated in FIG. 2A. In the example of FIG. 2A, the familiarity is represented by a numerical value from 1 to 7, and the larger the numerical value is, the higher the familiarity is. When the number of words in this histogram is cumulatively added in descending order of familiarity, a histogram illustrating the relationship between the familiarities of words and the estimated vocabulary sizes of people who know the words is obtained as illustrated in FIG. 2B. Because it is assumed that a person who knows a test word knows all the words with higher familiarities than the test word, the value obtained by cumulatively adding the number of words in descending order of familiarity is the estimated vocabulary size of people who know the words of each familiarity. As described above, the vocabulary size estimation unit 15 obtains a set of each test word w(n) in the word familiarity DB and the potential vocabulary size x(n) of each test word w(n). As a result, a table [W, X] is obtained in which the familiarity order word sequence W having the plurality of test words w(1), . . . , w(N) ranked (ordered) and the potential vocabulary sequence X having a plurality of potential vocabulary sizes x(1), . . . , x(N) ranked are associated with each other. The familiarity order word sequence W is a sequence having a plurality of test words w(1), . . . , w(N) as elements, and the potential vocabulary sequence X is a sequence having a plurality of potential vocabulary sizes x(1), . . . , x(N) as elements. In the table [W, X], each test word w(n) corresponds to each potential vocabulary size x(n) for all n=1, . . . , N. In the familiarity order word sequence, the plurality of test words w(1), . . . , w(N) are ranked to have the order based on the familiarities of the test words w(1), . . . , w(N) (the order based on the degree of familiarities of the test words). In the potential vocabulary size sequence, the plurality of potential vocabulary sizes x(1), . . . , x(N) are ranked based on the familiarities of the plurality of test words w(1), . . . , w(N) corresponding to the potential vocabulary sizes. The order based on familiarity may be ascending order of familiarity or may be descending order of familiarity. If the order based on familiarity is ascending, and n₁, n₂∈{1, . . . , N} and n₁<n₂, then the familiarity of the test word w(n₂) is greater than or equal to the familiarity of the test word w(n₁). On the other hand, if the order based on familiarity is descending, and n₁, n₂∈{1, . . . , N} and n₁<n₂, then the familiarity of the test word w(n₁) is greater than or equal to the familiarity of the test word w(n₂). The table [W, X] in which a familiarity order word sequence W having test words w(1), . . . , w(N) arranged in descending order of familiarity as elements and a potential vocabulary size sequence X having potential vocabulary sizes x(1), . . . , x(N) as elements are associated with each other is illustrated below (step S152).

| w(n) | x(n) |
|---|---|
| Bank | 722 |
| Economy | 1564 |
| Large portion | 2353 |
| Traffic jam | 2669 |
| Responsible | 2968 |
| Transportation | 3700 |
| Abundant | 4507 |
| Gene | 4950 |
| Configuration | 5405 |
| General public | 6401 |
| Nickname | 6947 |
| Passing | 8061 |
| Befall | 8695 |
| Dividend | 9326 |
| Domain | 9982 |
| Commencement | 10640 |
| Spearhead | 11295 |
| Adjustment | 11927 |
| Cross each other | 12670 |
| Hinder | 13364 |
| Incineration | 14120 |
| Expedition | 14811 |
| Boundary | 15621 |
| Gushing | 16387 |
| Capture | 17127 |
| General term | 17888 |
| Mitigate | 18604 |
| Base | 19264 |
| Eyeballing | 20008 |
| Fulfillment | 20764 |
| In unison | 21532 |
| Boundary line | 22232 |
| Another side | 22930 |
| Authority | 23587 |
| Enactment | 24286 |
| Vain | 25028 |
| Metaphor | 25716 |
| Brusqueness | 26339 |
| Abolition | 27597 |
| Chord | 28882 |
| Mingle | 29512 |
| Head | 30158 |
| Rock garden | 33144 |
| Interposition | 37357 |
| Founder | 46942 |
| Uprising | 53594 |
| Formulation | 55901 |
| Fruition | 58358 |
| Intimacy | 69475 |
| Recasting | 71224 |

Next, the vocabulary size estimation unit 15 refers to the number of people who know each test word w(n) (where, n=1, . . . , N) stored in the word familiarity DB of the storage unit 11, and sets the test words w(1), . . . , w(N) rearranged in the order based on the familiarities within the subjects a(1), . . . , a(N) (the order based on the degrees of the familiarities within the subjects) as test words w′(1), . . . , w′(N). That is, the test words w′(1), . . . , w′(N) are ranked based on the familiarities within the subjects a′(1), . . . , a′(N) corresponding to the test words w′(1), . . . , w′(N) of the subjects belonging to the subject set. Here, a′(n) is the familiarity within the subjects of the test word w′(n). Note that, in a case where the order based on the familiarity described above is the ascending order of the familiarity, the order based on the familiarity within the subjects is also the ascending order of the familiarity within the subjects. In a case where the order based on the familiarity is the descending order of the familiarity, the order based on the familiarity within the subjects is also the descending order of the familiarity within the subjects. That is, w′(1), . . . , w′(N) is a rearrangement of the order of w(1), . . . , w(N), and {w′(1), . . . , w′(N)}={w(1), . . . , w(N)} is satisfied. If the order based on the familiarity within the subjects is ascending, and n₁, n₂∈{1, . . . , N} and n₁<n₂, then the familiarity within the subjects a(n₂) of the test word w′(n₂) is greater than or equal to the familiarity within the subjects a(n₁) of the test word w′(n₁). For example, in a case where N=5, the order based on the familiarity within the subjects is ascending order, and a(2)<a(1)<a(3)<a(5)<a(4), the vocabulary size estimation unit 15 rearranges w(1), w(2), w(3), w(4), and w(5) into w′(1)=w(2), w′(2)=w(1), w′(3)=w(3), w′(4)=w(5), and w′(5)=w(4). On the other hand, if the order based on the familiarity within the subjects is descending order, and n₁, n₂∈{1, . . . , N} and n₁<n₂, the familiarity within the subjects a(n₁) of the test word w′(n₁) is greater than or equal to the familiarity within the subjects a(n₂) of the test word w′(n₂). For example, in a case where N=5, the order based on the familiarity within the subjects is descending order, and a(2)>a(1)>a(3)>a(5)>a(4), the vocabulary size estimation unit 15 rearranges w(1), w(2), w(3), w(4), and w(5) into w′(1)=w(2), w′(2)=w(1), w′(3)=w(3), w′(4)=w(5), and w′(5)=w(4). Note that, in either case, the potential vocabulary sizes x(1), . . . , x(N) are not rearranged. As a result, the vocabulary size estimation unit 15 obtains a table [W′, X] in which a test word sequence W′, which is a sequence having the test words w′(1), . . . , w′(N) as elements, and the potential vocabulary size sequence X, which is a sequence having the potential vocabulary sizes x(1), . . . , x(N) as elements, are associated with each other. The table [W′, X] obtained by rearranging the familiarity order word sequence W of the table [W, X] illustrated in step S152 in the descending order of the familiarities within the subjects a(1), . . . , a(N) is illustrated below (step S153).

| w′(n) | x(n) |
|---|---|
| Bank | 722 |
| Responsible | 1564 |
| Adjustment | 2353 |
| Passing | 2669 |
| Capture | 2968 |
| Configuration | 3700 |
| Gene | 4507 |
| Transportation | 4950 |
| Spearhead | 5405 |
| Cross each other | 6401 |
| Economy | 6947 |
| Traffic jam | 8061 |
| Mingle | 8695 |
| Boundary | 9326 |
| Abundant | 9982 |
| Boundary line | 10640 |
| Eyeballing | 11295 |
| Authority | 11927 |
| Gushing | 12670 |
| Enactment | 13364 |
| Domain | 14120 |
| Nickname | 14811 |
| Base | 15621 |
| Rock garden | 16387 |
| Mitigate | 17127 |
| Another side | 17888 |
| Head | 18604 |
| Dividend | 19264 |
| Vain | 20008 |
| Befall | 20764 |
| Large portion | 21532 |
| Incineration | 22232 |
| Brusqueness | 22930 |
| Commencement | 23587 |
| Hinder | 24286 |
| Expedition | 25028 |
| Chord | 25716 |
| General public | 26339 |
| Abolition | 27597 |
| General term | 28882 |
| Fulfillment | 29512 |
| In unison | 30158 |
| Founder | 33144 |
| Formulation | 37357 |
| Metaphor | 46942 |
| Fruition | 53594 |
| Interposition | 55901 |
| Intimacy | 58358 |
| Uprising | 69475 |
| Recasting | 71224 |

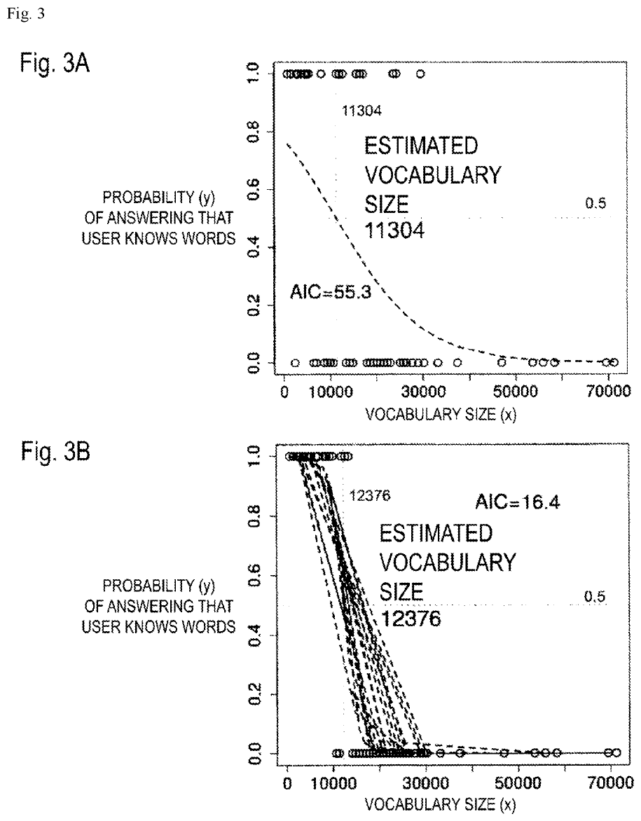

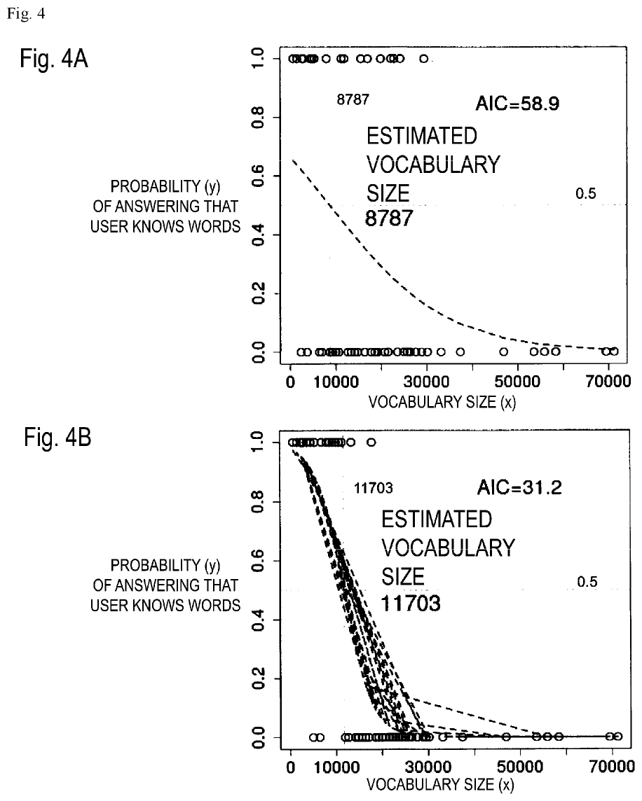

The vocabulary size estimation unit 15 uses a set (w′(n), x(n)) of a test word w′(n) and a potential vocabulary size x(n) of each rank (equal rank, the same rank in each row) n=1, . . . , N extracted from the test words w′(1), . . . , w′(N) of the test word sequence W′ and the potential vocabulary sizes x(1), . . . , x(N) of the potential vocabulary sequence X, and the answers regarding the knowledge of the test words of the users 100, to obtain a model φ representing the relationship between the values (for example, function values) based on the probabilities that the users 100 answer that the users know the words and the values (for example, function values) based on the vocabulary sizes of the users 100 when the users 100 answer that the users know the words. The values based on the probabilities that the users 100 answer that the users know the words may be the probabilities itself, may be correction values of the probabilities, may be monotonically non-decreasing function values of the probabilities, or may be other function values of the probabilities. The values based on the vocabulary sizes of the users 100 when the users 100 answer that the users know the words may be the vocabulary sizes itself, may be correction values of the vocabulary sizes, or may be other function values of the vocabulary sizes. The model φ may further represent the relationship between the values based on the probabilities that the users 100 answer that the users know the words and the values based on the vocabulary sizes of the users 100 when the users 100 answer that the users do not know the words (or when the users do not answer that the users know the words). The model φ is not limited, but an example of the model φ is a logistic regression model. For the sake of simplicity of description, in the following, a case is illustrated in which the values based on the probabilities that the users 100 answer that the users know the words are the probabilities itself, the values based on the vocabulary sizes of the users 100 when the users 100 answer that the users know the words are the vocabulary sizes itself, and the model φ is the logistic curve y=f(x, Ψ) with the vocabulary size as the independent variable x and the probability that the users 100 answer that the users know each word is the dependent variable y. Here, Ψ is a model parameter. In the case of this example, for the test word w′(n) that the user 100 has answered that the user knew, the vocabulary size estimation unit 15 sets the point (x, y)=(x(n), 1) where the probability y that the user 100 answers that the user knows the test word w′(n) is 1 (that is, 100%), and the potential vocabulary size x corresponding to the test word w′(n) is x(n). For the test word w′(n) that the user 100 has answered that the user does not know (or does not answer that the user know), the vocabulary size estimation unit 15 sets the point (x, y)=(x(n), 0) where the probability y that the user 100 answers that the user knows the test word w′(n) is 0 (that is, 0%), and the potential vocabulary size x corresponding to the test word w′(n) at that time is x(n). The vocabulary size estimation unit 15 applies a logistic curve to each point (x, y)=(x(n), 1) or (x(n), 0) of n=1, . . . , N, to obtain the logistic curve y=f(x, Ψ) that minimizes an error as the model φ. That is, the vocabulary size estimation unit 15 obtains the logistic curve y=f(x, Ψ) that minimizes the error as the model φ for each point (x, y)=(x(n), 1) or (x(n), 0) of n=1, . . . , N. FIGS. 3B and 4B illustrate models φ of logistic curve y=f(x, Ψ). In FIGS. 3B and 4B, the horizontal axis represents the potential vocabulary size (x), and the vertical axis represents the probability (y) of answering that the user knows words. The circles represent points (x, y)=(x(n), 1) for the test words w′(n) that the user 100 has answered that the user know, and points (x, y)=(x(n), 0) for the test words w′(n) that the user 100 has answered that the user does not know (or does not answer that the user know). In FIGS. 3B and 4B, a plurality of models φ of the plurality of users 100 are represented by dotted logistic curves (step S154).

The vocabulary size estimation unit 15 outputs a value based on the potential vocabulary size when the value based on the probability that the user 100 answers that the user knows the words is a predetermined value or in the vicinity of the predetermined value as the estimated vocabulary size of the user 100 in the model φ. For example, the vocabulary size estimation unit 15 outputs the potential vocabulary size in which the probability that the user 100 answers that the user knows the words is a predetermined value or in the vicinity of the predetermined value (for example, a predetermined value such as 0.5 or 0.8 or its vicinity) as the estimated vocabulary size of the user 100 in the model φ. For example, in the examples of FIGS. 3B and 4B, for a certain model φ, the potential vocabulary size having the probability y that the user 100 answers that the user knows the words is 0.5 is set as the estimated vocabulary size. Specifically, x=12376 in FIG. 3B and x=11703 in FIG. 4B are set as estimated vocabulary sizes (step S155).

### Characteristics of Present Embodiment

In the present embodiment, the vocabulary size estimation unit 15 rearranges a plurality of test words w(1), . . . , w(N) ranked to have the order based on the familiarity into the order based on the familiarities within the subjects a(1), . . . , a(N) to obtain a test word sequence W′ having a test word sequence w′(1), . . . , w′(N) as elements, and obtains a potential vocabulary sequence X having potential vocabulary sizes x(1), . . . , x(N) as elements, which are estimated based on predetermined familiarities for words and ranked to have the order based on the familiarities. Then, the vocabulary size estimation unit 15 uses a set (w′(n), x(n)) of a test word w′(n) and a potential vocabulary size x(n) of each rank n=1, N extracted from a table [W′, X] associating the test word sequence W′ and the potential vocabulary sequence X, and the answers regarding the knowledge of the test words of the users, to obtain a model φ representing the relationship between the values based on the probabilities that users know the words and the values based on the vocabulary sizes of the users. Here, the accuracy of the model φ is improved by rearranging the test words w(1), . . . , w(N) in the order based on the familiarities within the subjects a(1), . . . , a(N), and associating each of the potential vocabulary sizes x(1), . . . , x(N) with the test word sequence w′(1), . . . , w′(N) ranked to have the order based on the familiarities within the subjects a′(1), . . . , a′(N). This improves the estimation accuracy of the vocabulary size.

That is, as in the conventional method, in a case where the vocabulary size when the user 100 answers that the user knows each word is estimated based on predetermined familiarities for the words, the predetermined familiarities may be inappropriate for the subject set to which the user 100 belongs. In such a case, the vocabulary of the user 100 cannot be estimated accurately. For example, even for words with high familiarity (for example, words with familiarity of 6 or greater) such as “bank”, “economy”, and “large portion” that almost every adult would know, in a survey of sixth graders, there are big differences in the ratios of children who answered that they “knew” the target words such as 99.3% for “bank”, 73.8% for “economy”, and 48.6% for “large portion”. That is, in the conventional method, there is a big difference in the estimation results depending on which words are used as the test words even for words with close familiarity.

Because the familiarities of words vary depending on the survey period, in the conventional method, it is expected that the longer the period is from the survey period of familiarity to the vocabulary size estimation period, the lower the accuracy of the vocabulary size estimation is. For example, words such as anaphylaxis, leggings, and manifests have significantly increased familiarity compared to 20 years ago, while words such as prince melon, blank video tape, and millibar have significantly decreased familiarity (for example, see Reference 1). Thus, if the vocabulary size is estimated by the conventional method by using these words as test words, the estimation error will be large.

Reference 1: Sanae Fujita, Tetsuo Kobayashi, “Reexamination of Word Familiarity and Comparison with Past Examination,” Proc. of the 26th Annual Meeting of the Association for Natural Language Processing, Mar. 2020.

On the other hand, in the present embodiment, because the estimated vocabulary size is associated with each test word based on the familiarities within the subjects to the test words of the subjects belonging to the subject set, the estimated vocabulary size can be accurately obtained from the answers regarding the knowledge of the test words of the users.

FIGS. 3 and 4 illustrate a comparison of the models obtained by the conventional method and the method according to the present embodiment. FIGS. 3A and 4A illustrate the models obtained by the conventional method, and FIGS. 3B and 4B illustrate the models obtained by the present embodiment by using the same word familiarity DB and answers as in FIGS. 3A and 4A, respectively. In FIGS. 3A and 4A as well, the horizontal axis represents the potential vocabulary size (x), and the vertical axis represents the probability (y) of answering that the user knows words. The circles in FIGS. 3A and 4A represent points (x, y)=(x(n), 1) for the test words w(n) that the user answered that the user knew, and points (x, y)=(x(n), 0) for the test words w(n) that the user answered that the user did not know. The AIC in the figures represents the Akaike Information Criterion, and the smaller the value is, the better the fit of the model is. In FIG. 3A, AIC=55.3, whereas in FIG. 3B, AIC=16.4, and in FIG. 4A, AIC=58.9, whereas in FIG. 4B, AIC=31.2. In either case, it can be seen that the AIC of the present embodiment is smaller than that of the conventional method, and the model fits better. In addition, in a survey of 413 sixth graders, for 352 (85.2%), the AIC was smaller in the present embodiment than in the conventional method. As described above, in the present embodiment, the vocabulary size of the user can be estimated by a well-fitted model.

### Modification of First Embodiment

As illustrated in the first embodiment, it is easy to implement that the presentation unit 13 presents all N test words, and the answer reception unit 14 receives answers regarding the knowledge of the test words of the user for all the N test words. However, the presentation unit 13 may present the test words in order, and each time a test word is presented, the answer reception unit 14 may receive an answer regarding the knowledge of the test words of the user. At this time, the presentation of the questions may be stopped when the user answers P times (P is an integer of 1 or greater, preferably an integer of 2 or greater; P is preset) that the user does not know the presented test word. In this case, for the test words for which the user has not answered, each process is executed regarding that the user has answered that the user does not know the test word. Alternatively, in a case where the user answers that the user does not know the presented test word, another test word with the same degree of familiarity as (or with a little higher familiarity than) the test word may be presented, and the answer reception unit 14 may receive an answer regarding the knowledge of the test word of the user. By testing in detail around the familiarity of the test word that the user answered that the user did not know, it is possible to improve the accuracy of estimating the vocabulary size of the user.

In the first embodiment, an example is illustrated in which the total number of words having higher familiarities than each test word w(n) in the word familiarity DB is set as the potential vocabulary size x(n) when each test word is known, but the present invention is not limited to this. For example, a value (for example, a function value such as a non-monotonically non-decreasing function value) based on the total number of words having higher familiarities than each test word w(n) in the word familiarity DB may be set as the potential vocabulary size x(n) when each test word is known.

Instead of executing the processes of steps S12, S13, S14, S151, S152, S153, S154, and S155 for each user 100, the processes of steps S152, S153, S154, and S155 may not be executed until the processes of steps S12, S13, S14, and S151 are executed for a predetermined number of users 100 (subjects). After the processes of steps S12, S13, S14, and S151 are executed for a predetermined number of users 100 (subjects), the count-up of the number of people who know the test word w(n) in step S151 may be stopped.

After the steps S12, S13, S14, and S151 are executed for the same test words w(1), . . . , w(N) for a predetermined number of users 100 and the table [W′, X] is further obtained in steps S152 and S153, the table [W′, X] may be stored in the storage unit 11. As a result, if the same test words w(1), . . . , w(N) are used, the vocabulary size estimation unit 15 does not need to calculate the table [W′, X] every time in the subsequent vocabulary size estimation. In this case, the vocabulary size estimation unit 15 may extract a set (w′(n), x(n)) of test words w′(n) and potential vocabulary sizes x(n) of each rank n=1, N from the table [W′, X] stored in the storage unit 11, and use these and the answers regarding the knowledge of the test words of the users 100 received by the answer reception unit 14 to obtain the above-mentioned model φ.

### Second Embodiment

Next, a second embodiment of the present invention will be described. The second embodiment is a modification for the first embodiment and a modification for the modification of the first embodiment, and differs from these in that test words are selected from words other than those characteristic of the text in specific fields. Hereinafter, the differences between the first embodiment and the modification of the first embodiment will be mainly described, and the same reference numerals will be used for the matters already described to simplify the description.

For children in the curriculum, it is expected that the familiarities of words that appear in textbooks or are learned as important terms will be higher than the familiarities of the words for adults. Thus, for example, in a case where words that appear in textbooks or words that have just been learned are used as test words and the vocabulary size estimation is performed for children in the curriculum, the estimated vocabulary sizes may become too large. For example, the word “metaphor” is learned in the first grade of junior high school. Thus, compared to other words with similar familiarity, the ratio of people who know the word jumps sharply in the first grade of junior high school. If such words are used as test words in the vocabulary size estimation of the users 100 in the first grade of junior high school, the estimated vocabulary sizes may become too large. This similarly applies to words that appear as important words in certain units of science, social studies, and the like, such as transverse wave, manor, or organic matter.

Thus, in a case of performing the vocabulary size estimation of users 100 for children in the curriculum, it is desirable not to use the words in the text of the textbooks (text of the textbook fields) as test words. However, if all the words included in the text of the textbooks are not used as test words, general words included in the text of the textbooks cannot be used as the test words. Thus, it is desirable not to use only words that are characteristic of the text in textbooks as the test words. Words that are characteristic of the text in textbooks are, for example, words that appear repeatedly in certain units, words that appear as important words, or words that appear only in certain subjects. Whether or not such a word appears characteristically in a textbook can be determined, for example, by whether or not the word is characteristic of a textbook (for example, a word having a significantly high degree of characteristic) in a known textbook corpus vocabulary table.

### Textbook Corpus Vocabulary Table:

https://pj.ninjal.ac.jp/corpus_center/bccwj/freq-list.html
For example, “chord” has a degree of characteristic of 390.83 in all subjects in elementary, junior high, and high schools and a degree of characteristic of 11.28 in all subjects in elementary school in the textbook corpus vocabulary table, and thus “chord” is a word that appears characteristically in textbooks. On the other hand, “capture” has a degree of characteristic of 0.01 in all subjects in elementary school, which is close to 0, and thus there is almost no difference in use in textbooks and general documents. Thus, for example, it is desirable to use a word whose absolute value of the degree of characteristic is less than or equal to a threshold value in the textbook corpus vocabulary table as a test word. More preferably, it is desirable to use a word having a degree of characteristic close to 0 in the textbook corpus vocabulary table as a test word. Depending on the attributes of the users 100, the determination whether or not to exclude a word from the test word candidates may use the degree of characteristics of elementary school textbooks, may use the degree of characteristics of textbooks of specific subjects, or may use the degree of characteristics of textbooks of specific grades. For example, in a case of estimating the vocabulary sizes of users 100 of elementary school students, words including Kanji that are not learned in elementary school may be excluded from the test word candidates. Similarly, in a case of estimating the vocabulary size of users 100 of adults, words characteristic of the text in certain specialized fields may be excluded from the test word candidates. As described above, in the present embodiment, the test words are selected from words other than the words characteristic of the text in specific fields. Hereinafter, a detailed description will be given.

As illustrated in FIG. 1, a vocabulary size estimation apparatus 2 according to the present embodiment includes a storage unit 21, a question generation unit 22, a presentation unit 13, an answer reception unit 14, and a vocabulary size estimation unit 15. The only difference from the first embodiment is the storage unit 21 and the question generation unit 22. In the following, only the storage unit 21 and the question generation unit 22 will be described.

### Storage Unit 21

The difference from the storage unit 11 of the first embodiment is that the storage unit 21 stores a specific field word DB in which words characteristic of the text in specific fields are stored in addition to the word familiarity DB. Examples of specific fields are textbooks fields and specialized fields. The textbook fields may be all textbook fields, or may be textbook fields of specific grades, or may be textbook fields of specific subjects. The specialized fields may be all specialized fields or may be specific specialized fields. The specific field word DB is, for example, a textbook DB that records words described as words that characteristically frequently appear in the textbook corpus vocabulary table, a specialized word DB that records words described as words that characteristically frequently appear in specialized books or specialized corpus, or the like (step S21). Others are the same as those in the first embodiment.

### Question Generation Unit 22

When the question generation unit 22 receives the question generation request from the user or the system as an input, the question generation unit 22 selects and outputs a plurality of test words w(1), . . . , w(N) to be used in the vocabulary size estimation test from a plurality of words included in the word familiarity DB of the storage unit 21. The difference of the question generation unit 22 from the question generation unit 12 is that the test words are selected from the storage unit 21 instead of the storage unit 11, and the test words are selected from words other than those characteristic of the text in specific fields. Specifically, the question generation unit 22 refers to, for example, the word familiarity DB and the specific field word DB stored in the storage unit 21, selects N words that are recorded in the word familiarity DB and not recorded in the specific field word DB (for example, select N words at substantially regular intervals in the order of the familiarity), and outputs the selected N words as test words w(1), . . . , w(N). Others are the same as those in the first embodiment (step S22).

### Modification of Second Embodiment

In the second embodiment, an example is illustrated in which the question generation unit 22 refers to the word familiarity DB and the specific field word DB stored in the storage unit 21, and selects N words that are recorded in the word familiarity DB and are not recorded in the specific field word DB. However, a vocabulary list that can be used or is desired to be used for the test (that is, a vocabulary list having words other than the words that are characteristic of the text in specific fields as elements) may be prepared in advance, and test words that satisfy the condition such as familiarity as described above may be selected from the list. A vocabulary list that can be used for purposes other than vocabulary size estimation may be prepared in advance, and test words may be selected from the list.

The storage unit 21 may store a topical word DB in which words with high topicality are stored. In this case, the question generation unit 22 may refer to the word familiarity DB and the topical word DB stored in the storage unit 21, select N words that are recorded in the word familiarity DB and not recorded in the topical word DB, and set the selected N words as test words. Words with high topicality are words that are characteristic of the text at specific times, that is, words that attracted attention at specific times. In other words, words with high topicality means words that appear more frequently in the text at specific times than in the text at other times. The following are examples of words with high topicality.
Words whose highest value of frequency of appearance in the text at specific times is higher than the highest value of frequency of appearance in the text at other times
Words whose average value of frequency of appearance in the text at specific times is higher than the average value of frequency of appearance in the text at other times
Words whose value obtained by subtracting the highest value of frequency of appearance in the text at other times from the highest value of frequency of appearance in the text at specific times is larger than a positive threshold value
Words whose value obtained by subtracting the average value of the frequency of appearance in the text at other times from the average value of the frequency of appearance in the text at specific times is larger than a positive threshold value
Words in which the ratio of the highest value of the frequency of appearance in the text at specific times to the highest value of the frequency of appearance in the text at other times is greater than a positive threshold value
Words in which the ratio of the average value of the frequency of appearance in the text at specific times to the average value of the frequency of appearance in the text at other times is greater than a positive threshold value
   The text at specific times and the text at other times is, for example, text in at least any one or more media of an SNS, a blog, a newspaper article, and a magazine.
   For example, words with high topicality such as “coronavirus” and “cluster” have greatly different familiarities depending on the time of the survey. In a case of performing the vocabulary size estimation by using such words as test words, it may not be possible to correctly perform the vocabulary size estimation depending on the time when the answers regarding the knowledge of the test words of the users are received. For example, in a case where words with high topicality whose familiarity is significantly different between the time when the familiarities of the word familiarity DB were surveyed and the time when the answers regarding the knowledge of the test words of the user are received for the vocabulary size estimation, the vocabulary size estimation cannot be performed. Thus, it is desirable for the question generation unit to select test words from words other than those with high topicality.

Note that, instead of selecting N words that are recorded in the word familiarity DB and not recorded in the topical word DB and setting the selected N words as test words, a vocabulary list that can be used or is desired to be used for the test (that is, a vocabulary list having words other than words with high topicality as elements) may be prepared in advance, and test words that satisfy the condition such as familiarity as described above may be selected from the list. In this case as well, a vocabulary list that can be used for purposes other than vocabulary size estimation may be prepared in advance, and test words may be selected from the list.

In addition, words that are neither words characteristic of the text in specific fields nor words with high topicality may be selected as test words. That is, the question generation unit 22 may select test words from words other than words characteristic of the text in specific fields and/or words with high topicality.

### Third Embodiment

Next, a third embodiment of the present invention will be described. The third embodiment is a further modification for the first embodiment and a further modification for the modification of the first embodiment, and differs from these in that words whose adequacy of the notation meets predetermined criteria are selected as test words.

In the third embodiment, among the plurality of words included in the word familiarity DB, words whose adequacy of the notation meets predetermined criteria are selected as test words. This is to avoid confusion for the users 100 by setting words having notations that are not normally used as test words. Examples of words whose adequacy of the notation meets predetermined criteria are words having high adequacy of the notation, that is, words whose value (index value) indicating the degree of adequacy of the notation is greater than or equal to a predetermined threshold value (first threshold value) or exceeds the threshold value. In this case, words whose value indicating the degree of adequacy of the notation is greater than or equal to a predetermined threshold value or exceeds the threshold value are used as test words. Other examples of words whose adequacy of the notation meets certain criteria are words in which the rank of the value indicating the adequacy of the notation is higher than a predetermined rank among a plurality of notations (for example, words with the highest rank of the value indicating the degree of the adequacy among the plurality of notations). In this case, words with higher rank than a predetermined rank of values indicating the degree of the adequacy of the notation are used as test words. As the values indicating the degree of the adequacy of the notation, for example, those described in Shigeaki Amano, Kimihisa Kondo, “Lexical Properties of Japanese Vol. 2”, Sanseido, Tokyo, 1999 (Reference 2) can be used. That is, in Reference 2, the adequacy of each notation when there may be a plurality of notations for the same entry is expressed by a numerical value. This numerical value can be used as a “value indicating the degree of the adequacy of the notation”. In Reference 2, the adequacy of each notation is expressed by a numerical value from 1 to 5, and for example, the adequacy of “cross each other (KU-I-CHIGA-U in Kanji)” is expressed by 4.70, and the adequacy of “cross each other (KUI-CHIGA-U in Kanji)” is expressed by 3.55. The larger the numerical value is, the higher the adequacy is. In this case, “cross each other (KUI-CHIGA-U in Kanji)” with the lower adequacy is not used as a test word. In a case where a plurality of notations are used for the same entry in the corpus, the frequency of application of notation in this corpus may be used as a “value indicating the degree of the adequacy of the notation”.

The plurality of words included in the word familiarity DB may be only words whose indexes representing the individual differences in familiarity with the words are less than or equal to a threshold value (second threshold value) or below the threshold value. The smaller the value of the index is, the smaller the individual difference in familiarity with the word is. An example of such an index is the variance of answers when a plurality of subjects make answers regarding the knowledge (for example, answers that the subjects know a word, answers that the subjects do not know a word, and the like). A high variance means that the evaluation of whether the word is familiar varies greatly from person to person. By excluding words with high variance from the word familiarity DB, it is possible to suppress the variation in the estimation errors of the vocabulary sizes depending on the users 100. Hereinafter, a detailed description will be given.

As illustrated in FIG. 1, a vocabulary size estimation apparatus 3 according to the present embodiment includes a storage unit 31, a question generation unit 32, a presentation unit 13, an answer reception unit 14, and a vocabulary size estimation unit 15. The only difference from the first embodiment is the storage unit 31 and the question generation unit 32. In the following, only the storage unit 31 and the question generation unit 32 will be described.

### Storage Unit 31

The difference between the storage unit 31 and the storage unit 11 according to the first embodiment is that the word familiarity DB stored in the storage unit 31 associates words whose indexes (for example, the variance of the answers mentioned above) representing the individual differences in familiarity with the words are less than or equal to a threshold value or below the threshold value, with the familiarities of the words, and in addition to the word familiarity DB, the storage unit 31 also stores a notation adequacy DB in which values indicating the degrees of adequacy of the notations of each word in the word familiarity DB (for example, numerical values indicating the adequacies of each notation described in Reference 2, or the frequencies of application of the notations in the corpus) are recorded (step S31). Others are the same as those in the first embodiment.

### Question Generation Unit 32

When the question generation unit 32 receives the question generation request from the user or the system, the question generation unit 32 selects and outputs a plurality of test words w(1), . . . , w(N) to be used in the vocabulary size estimation test from a plurality of words included in the word familiarity DB of the storage unit 31. The difference of the question generation unit 32 from the question generation unit 12 is that the test words are selected from the storage unit 31 instead of the storage unit 11, and words whose degrees of adequacy of the notations meet the certain criteria are selected as the test words. Specifically, the question generation unit 32 refers to, for example, the word familiarity DB and the notation adequacy DB stored in the storage unit 31, selects N words that are recorded in the word familiarity DB and whose adequacy of the notation meets the predetermined criteria (for example, select N words at substantially regular intervals in the order of the familiarity), and outputs the selected N words as test words w(1), . . . , w(N). Others are the same as those in the first embodiment (step S32).

### Fourth Embodiment

The fourth embodiment is a modification for the first to third embodiments and a modification for the modification of the first embodiment, and is different from these in that an appropriate estimated vocabulary size is estimated for words other than the test words.

As described above, if the vocabulary size estimation is performed by the method described in the first embodiment or the like, the accuracy of the model φ is improved and the vocabulary sizes of the users can be estimated with high accuracy. However, in this method, the familiarity within the subjects a′(n) of each test word w′(n) is required in order to obtain an appropriate potential vocabulary size x(n) corresponding to each test word w′(n). In order to obtain the familiarity within the subjects a′(n) of each test word w′(n), it is necessary to execute the processes of steps S12, S13, S14, and S151 for a certain number or more of users 100 (subjects) belonging to the subject set. In a case where the test words are changed, the familiarities within the subjects corresponding to the changed test words are required, and the processes of steps S12, S13, S14, and S151 must be redone for a certain number or more of users 100 belonging to the subject set. Thus, this method has a problem that the change of the test words is complicated.

Thus, in the present embodiment, the potential vocabulary size x″(m) appropriate for the users 100 belonging to the subject set is estimated for each word w″(m) (where, m=1, . . . , M) of M words w″(1), . . . , w″(M) in the word familiarity DB without redoing the processes in steps S12, S13, S14, and S151. As a result, change of the test words is facilitated. In the present embodiment, an estimation model (estimation formula) Ψ:x″=G(γ₁, . . . , γ_{I}, Θ) for obtaining the potential vocabulary size x″ from the features (variables) γ₁, . . . , γ_{I} of the word w is obtained, and by applying the features γ₁(m), . . . , γ_{I}(m) of each word w″(m) to the variables γ₁, . . . , γ_{I} of this estimation model Ψ, the potential vocabulary size x″(m)=G(γ₁(m), . . . , γ_{I}(m), Θ) corresponding to each word w″(m) is obtained. However, I is a positive integer representing the number of features, and Θ is a model parameter. The estimation model is not limited, and anything can be used as long as the potential vocabulary size x″(m) is estimated from the features γ₁(m), . . . , γ_{I}(m), such as a multiple regression equation or a random forest. The model parameter Θ is obtained by machine learning by using a set (w′(n), x(n)) of a test word w′(n) and a potential vocabulary size x(n) of each rank n=1, . . . , N extracted from the test word w′(1), . . . , w′(N) of the test word sequence W′ and the potential vocabulary sizes x(1), . . . , x(N) of the potential vocabulary sequence X in the above-mentioned table [W′, X] as correct answer data (training data). For example, for n=1, . . . , N, a model parameter Θ that minimizes the error (for example, mean square error) between the potential vocabulary size x″(n)=G(γ₁(n), . . . , γ_{I}(n), Θ) obtained by applying the features γ₁(n), . . . , γ_{I}(n) of each test word w′(n) in the correct answer data to the estimation model Ψ and the potential vocabulary size x(n) of the correct answer data is estimated. Examples of the feature γᵢ are the imageability of the word w″ (easiness to image the word), the familiarity of the word w″ stored in the word familiarity DB, the value indicating whether or not the word w″ represents a concrete object, the frequency of appearance of the word w″ in the corpus, and the like. An example of the imageability is an average value evaluated in seven levels stored in Lexical Properties of Japanese 3rd term “Word Imageability Database” (http://shachi.org/resources/3472?ln=jpn). Alternatively, the five-level rating value or the average rating value of whether the result of a search by using a definition sentence in a dictionary for a word is appropriate as a meaning in a dictionary disclosed in Reference 3 or the like may be used as the imageability of the word. This five-level rating value indicates how easy it is to express the word as an image.

Reference 3: Same Fujita, Hirotoshi Taira, Masaaki Nagata, “Enriching Dictionaries with Images from the Internet”, Natural Language Processing, Vol. 20, No. 2, pp. 223-250, 2013. An example of the value indicating whether or not a word w″ represents a concrete object is a value indicating whether or not it is under “concrete” in A Japanese Lexicon (thesaurus).
As features γ₁, . . . , γ_{I}, all of the imageability of a word w″, the familiarity of the word w″, the value indicating whether or not the word w″ represents a concrete object, and the frequency of appearance of the word w″ in the corpus may be used, or some of these may be used (for example, the features γ₁, . . . , γ_{I} include the imageability of the word w″, but do not include the value indicating whether or not the word w″ represents a concrete object, or the features γ₁, . . . , γ_{I} include the value indicating whether or not the word w″ represents a concrete object, but do not include the imageability of the word w″), or other values may be used. Hereinafter, a detailed description will be given.

As illustrated in FIG. 1, a vocabulary size estimation apparatus 4 according to the present embodiment includes a storage unit 11, a question generation unit 12, a presentation unit 13, an answer reception unit 14, and a vocabulary size estimation unit 45. The only difference from the first embodiment is the vocabulary size estimation unit 45. In the following, only the vocabulary size estimation unit 45 will be described.

### Vocabulary Size Estimation Unit 45

The vocabulary size estimation unit 45 executes the processes of steps S151, S152, and S153 described above to obtain a table [W′, X], and stores the table [W′, X] in the storage unit 11. However, if the table [W′, X] is already stored in the storage unit 11, the processes of steps S151, S152, and S153 may be omitted. The vocabulary size estimation unit 45 obtains the model parameter Θ of the estimation model Ψ:x″=G(γ₁, . . . , γ_{I}, Θ) by machine learning by using the set (w′(n), x(n)) of the test word w′(n) and the potential vocabulary size x(n) of each rank n=1, . . . , N extracted from the test words w′(1), . . . , w′(N) of the test word sequence W′ and the potential vocabulary sizes x(1), . . . , x(N) of the potential vocabulary sequence X in the table [W′, X] as correct answer data. For example, in a case where the estimated model Ψ is a multiple regression equation, the estimated model Ψ is expressed by Equation (1) below.

x″=G(γ₁, . . . , γ_{I}, Θ)=θ₁γ₁+ . . . +θ_{I}γ_{I}+θ₀ (1)

Here, Θ={θ₀, θ₁, . . . , θ_{I}}. For example, in a case where I=4, γ₁ is the imageability of the word w″, γ₂ is the familiarity of the word w″, γ₃ is the value indicating whether or not the word w″ represents a concrete object, and γ₄ is the frequency of appearance of the word w″ in the corpus, the estimation model Ψ of the multiple regression equation is expressed by Equation (2) below.

x″=G(γ₁, . . . , γ_{I}, Θ)=θ₁γ₁+θ₂γ₂+θ₃γ₃+θ₄γ₄+θ₀ (2)

Here, Θ={θ₀, θ₁, . . . , θ_{I}} (step S454).

Next, the vocabulary size estimation unit 45 obtains the features γ₁(m), . . . , γ_{I}(m) of each word w″(m) (where, m=1, . . . , M) in the word familiarity DB of the storage unit 11, and substitutes these and the model parameter Θ obtained in step S454 into the estimation model Ψ to obtain the potential vocabulary size x″(m)=G(γ₁(m), . . . , γ_{I}(m), Θ) corresponding to each word w″(m). Each potential vocabulary size x″(m) is associated with each word w″(m) and stored in the storage unit 11 (step S455).

After that, in a case of performing the vocabulary size estimation, the processes of steps S151 to S153 can be omitted, and the processes of steps S12, S13, S14, S154, and S155 can be performed. However, in step S12, it is not necessary for the question generation unit 12 to select the same test words w(1), . . . , w(N) every time. In step S154, the vocabulary size estimation unit 15 obtains a model φ by using a set (w(n), x″(n)) of each test word w(n) selected in step S151 and a potential vocabulary size x″(n) associated with each test word w(n) in the storage unit 11 and the answers regarding the knowledge of the test word of the users 100.

### Modification of Fourth Embodiment

The vocabulary size estimation apparatus 4 may include the storage unit 21 and the question generation unit 22 described in the second embodiment or the modification thereof, instead of the storage unit 11 and the question generation unit 12 described in the first embodiment. In this case, the process of step S22 is executed instead of step S12, but in this case as well, it is not necessary for the question generation unit 22 to select the same test words w(1), . . . , w(N) every time. Similarly, the storage unit 31 and the question generation unit 32 described in the third embodiment may be provided. In this case, the process of step S32 is executed instead of step S12, but in this case as well, it is not necessary for the question generation unit 32 to select the same test words w(1), . . . , w(N) every time.

### Fifth Embodiment

The fifth embodiment is a modification for the first to fourth embodiments and a modification for the modification of the first embodiment. In the first to fourth embodiments and the modification of the first embodiment, the potential vocabulary size of each word is obtained by using a word familiarity DB storing a set of a plurality of words and a predetermined familiarity for each of the words. However, it may not be possible to prepare such a word familiarity DB. In the fifth embodiment, instead of such a word familiarity DB, the potential vocabulary size of each word is obtained at least based on the frequencies of appearance of words in a corpus. In this case, for example, instead of the word familiarity DB, a DB storing a plurality of words and the frequency of appearance of each of the words is used. Furthermore, in addition to the frequencies of appearance of the words in the corpus, the potential vocabulary size may be obtained based on the parts of speech of the words. In this case, for example, instead of the word familiarity DB, a DB storing a plurality of words and the frequency of appearance and the part of speech of each of the words is used. Furthermore, in addition to at least any one of these, the potential vocabulary size assumed for the subject may be obtained based on the familiarities (foreign language familiarity) of words in a language of people (for example, Americans) whose native language (for example, English) is different from the native language (for example, Japanese) of the subject (for example, Japanese person). In this case, instead of the word familiarity DB, a DB that stores a plurality of words, the frequency of appearance and/or the part of speech of each of the words, and the familiarities of the words in the language is used. Alternatively, as described above, the potential vocabulary sizes may be obtained from at least any one of the frequencies of appearance, the parts of speech, and the foreign language familiarities of the words, and instead of the word familiarity DB, a DB in which a set of a plurality of words and the potential vocabulary size obtained for each of the words are associated with each other may be used.

As described above, it may not be possible to obtain a word familiarity DB that stores a set of a plurality of words and a predetermined familiarity for each of the words. For example, in the first to fourth embodiments and the modification of the first embodiment, examples of performing the vocabulary size estimation of Japanese have been illustrated. However, the present invention is not limited to this, and the vocabulary size estimation of a language other than Japanese (for example, English) may be performed according to the present invention. However, there is no large-scale data of the familiarities of the words directed for non-native languages. For example, in a case where the users 100 are Japanese people, a language such as English other than Japanese is a non-native language. There are familiarity data of tens of thousands to hundreds of thousands of Japanese words for Japanese people, but there is no large-scale data of familiarities of English words for Japanese people. For example, in “English vocabulary familiarity of Japanese EFL learners” (Yokokawa, Kuroshio Publishers, 2006), the familiarities of English words have been surveyed for Japanese people, but the number of words is about 3000, which is not sufficient. There are data on the familiarity of English surveyed for native English speakers (Reference 4: https: //elexicon.wustl.edu/include/NewNews.html). However, the familiarities of English words will not necessarily match between native English speakers and Japanese people who are non-native English speakers.

Alternatively, it is also conceivable to estimate the familiarities of words by using the frequencies of appearance of words in the corpus. It is known that the frequency of appearance of a word in the corpus correlates with the familiarity of the word. However, there are words with high familiarity even though the frequency of application is low, and just because a word appears in the corpus infrequently does not necessarily mean that it is a word with low familiarity (difficult word).

There are English dictionaries in which each word is given a level of difficulty (for example, see Reference 5 and the like), but if the level of difficulty is divided into several levels, it is too coarse to perform the vocabulary size estimation by using these levels as familiarities. For example, in Reference 5, English words are divided into levels for the purpose of being used in Japanese English education, but the number of levels is only four, including A1, A2, B1, and B2 (A1<A2<B1<B2) (7815 words are recorded by part of speech). In this case, it would not be possible to assume that a person who knows one word of level A1 knows all the words of level A1. Note that, in the number of levels of these levels, α<β means that the word of level a is more difficult than the word of level β.

Reference 5: CEFR-J Wordlist (http://www.cefr-j.org/download.html#cefrj_wordlist)

Thus, in the present embodiment, on the basis of a vocabulary list in which English words are leveled for Japanese people (for example, CEFR-J Wordlist Version 1.6 in Reference 5), each level is further subdivided by further ranking each word within each level according to predetermined ranking criteria, and all the words is rearranged in the order estimated as the familiarity order of each word. Examples of the “predetermined ranking criteria” are criteria for ranking each word in order of frequency of appearance of each word in the corpus, or criteria for ranking each word in the order of the familiarity of native English speakers. For example, in the CEFR-J Wordlist of Reference 5, English words are given the following levels.

Level A1: a, a.m., about, above, action, activity, . . . , yours, yourself, zoo (1197 words, collectively 1164 words for notation fluctuations)
Level A2: ability, abroad, accept, acceptable, . . . , yeah, youth, zone (1442 words, collectively 1411 words for notation fluctuations)
Levels B1 and B2 are described in similar ways. Within each of these levels, words are ranked and rearranged according to the “predetermined ranking criteria”. For example, at level A1, words are rearranged in the order of the frequency of appearance, such as a, about, yourself,,,,. Words rearranged in the order of the frequency of appearance within each level A1, A2, B1, and B2 are arranged in the order estimated to be the familiarity order of each word as a whole. As described above, the potential vocabulary size x(m) is associated with each word ω(m) of M words ω(1), . . . , ω(M) arranged in the order estimated to be the familiarity order. Here, x(m₁)≤x(m₂) is satisfied for m₁, m₂∈{1, . . . , M} and m₁<m₂.

In a case where vocabulary size estimation is performed by ranking words in the order of the frequency of appearance in this way, it is desirable that the order of the frequencies of appearance of words and the order of the familiarities of words match as much as possible. However, it may not be obvious how to count the frequency of appearance depending on whether or not the word can be conjugated, such as that verbs can be conjugated but nouns cannot be conjugated. There may be differences in the tendency of appearance in the corpus depending on the part of speech, such as that the absolute number of nouns is higher than that of verbs and the relative frequency of nouns is lower. Thus, in a case of performing the vocabulary size estimation by ranking words in the order of the frequency of appearance, it is difficult to treat the words of all parts of speech with the same criteria. Thus, it is desirable to perform the vocabulary size estimation for each part of speech. That is, the vocabulary size estimation may be performed for each part of speech by using a table in which the potential vocabulary size x(m) is associated with each word ω(m) of M words ω(1), . . . , ω(M) having the same part of speech arranged in the order estimated to be the familiarity order as described above. Here, x(m₁)≤x(m₂) is satisfied for m₁, m₂∈{1, . . . , M} and m₁<m₂. In other words, the estimated vocabulary size of a person who knows a word ω(m₁) of a “specific part of speech” included in the words ω(1), . . . , ω(M) and whose frequency of appearance is α₁ (first value). z(m₁) is less than the estimated vocabulary size z(m₂) of a person who knows a word ω(m₂) of the “specific part of speech” whose frequency of appearance is α₂ (second value) (where, α₁ is larger than α₂; α₁>α₂). In a case where a plurality of parts of speech are conceivable for the same word, the familiarity of the word may differ depending on the part of speech. For example, the same word may be rarely used in one part of speech, but used often in another part of speech. In order to avoid such effects, if a plurality of parts of speech are conceivable for the same word, the vocabulary size estimation is performed for each part of speech by regarding the word as the word of the most familiar part of speech (for example, the part of speech with the lowest level of difficulty) among the plurality of parts of speech. That is, the vocabulary size estimation is performed for each part of speech by regarding the part of speech that is most familiar as the part of speech of the word ω(m₁) or the word ω(m₂) as the above-mentioned “specific part of speech” among the parts of speech of the word ω(m₁) or the word ω(m₂). For example, for the word “round”, parts of speech of adverb, adjective, noun, and preposition can be assumed as follows.

+−−−−−−−+−−−−−−−−−−−−−+−−−−−−+
| WORD | POS | CEFR |
+−−−−−−−+−−−−−−−−−−−−−+−−−−−−+
| round | adverb | A2 |
| round | adjective | B1 |
| round | noun | B1 |
| round | preposition | B2 |
| round | verb | B2 |
+−−−−−−−+−−−−−−−−−−−−−+−−−−−−+

Here, the levels of the adverb “round”, the adjective “round”, the noun “round”, and the preposition “round” are A2, B1, B1, B2, and B2, respectively. In this case, the vocabulary size estimation is performed by regarding “round” as the adverb word with the lowest level.

Hereinafter, the effects of ranking words based on the frequencies of appearance of words and the parts of speech of words in the corpus as described above will be illustrated.

(1) In a case where words are ranked to have the order of the frequencies of appearance of words in the corpus (using 1 gram data of Google Books after 1900) certain,private,directly,ago,agricultural,psychological,pretty,mostly,involve,competitive,elementary, adams,majesty,tide,peaceful,vain,asleep,inform,fled,neural,quit,sincere,auf,conquered,jay,behold,administer,envy,delete,scenery,triangular,fireplace,preparatory,canterbury,pike,tout,regimen, reunion,arousal,deacon,tread,strenuous,arsenal,blaze,inquisition,inexperienced,tremble,aerosol,balkans,rubbish
The levels described in CEFR-J Word List and the parts of speech (in the case where the word has a plurality of parts of speech, only one is described) are added to each word as follows: certain (A2, adjective), private (A2, adjective), directly (B1, adverb), ago (A1, adverb), agricultural (B1, adjective), psychological (B1, adjective), pretty (A2, adverb), mostly (A2, adverb), involve (B1, verb), competitive (B1, adjective), elementary (A1, adjective), adams (-,), majesty (-,), tide (B1, noun), peaceful (A2, adjective), vain (B1, adjective), asleep (A2, adjective), inform (B1, verb), fled (-,), neural (-,), quit (B2, adjective), sincere (B2, adjective), auf (-,), conquered (-,), jay (-,), behold (-,), administer (-,), envy (B2, verb), delete (B1, verb), scenery (A2, noun), triangular (-,), fireplace (B2, noun), preparatory (-,), canterbury (-,), pike (-,), tout (-,), regimen (-,), reunion (A2, noun), arousal (-,), deacon (-,), tread (B2, verb), strenuous (-,), arsenal (-,), blaze (B2, verb), inquisition (-,), inexperienced (B2, adjective), tremble (B1, verb), aerosol (-,), balkans (-,), rubbish (B1, noun)
For example, in the above list, adams and canterbury are often used as proper nouns such as Adams and Canterbury. It is not desirable to use words that are originally used as proper nouns for the vocabulary size estimation. By avoiding the use of words not included in the list such as CEFR-J, it is possible to avoid using such words. In the order of the frequency, the frequency of agricultural is higher than that of peaceful, but the levels of peaceful and agricultural in CEFR-J are A2 and B1 levels, respectively, and it is considered that the levels defined in CEFR-J are more intuitive (that is, peaceful is a word that is more familiar than agricultural to more people).

(2) An example in which only the words that appear in the CEFR-J Wordlist are used, and each word is further ranked to have the order of the frequency of appearance of each word in the corpus within each level certain, difficult, directly, ago, agricultural, psychological, pretty, mostly, involve, competitive, elementary, survive, evaluate, triumph, peaceful, vain, brave, inform, chin, enjoyment, imaginary, policeman, literal, thigh, absorb, erect, aristocracy, strangely, delete, distributor, dissatisfaction, tuition, likeness, tub, manipulate, homework, eloquence, comet, anyhow, fortnight, trainee, supervise, wetland, botany, enjoyable, razor, stimulant, dangerously, brilliantly, bully

For the sake of clarity, the levels in CEFR and the parts of speech are added to each of the words described above as follows:
[A2] certain (adjective), [A1] difficult (adjective), [B1] directly (adverb), ago (adverb), agricultural (adjective), psychological (adjective), pretty (adverb), mostly (adverb), involve (verb), competitive (adjective), elementary (adjective), survive (verb), [B2] evaluate (verb), triumph (noun), peaceful (adjective), vain (adjective), brave (adjective), inform (verb), chin (noun), enjoyment (noun), imaginary (adjective), policeman (noun), literal (adjective), thigh (noun), absorb (verb), erect (adjective), aristocracy (noun), strangely (adverb), delete (verb), distributor (noun), dissatisfaction (noun), tuition (noun), likeness (noun), tub (noun), manipulate (verb), homework (noun), eloquence (noun), comet (noun), anyhow (adverb), fortnight (noun), trainee (noun), supervise (verb), wetland (noun), botany (noun), enjoyable (adjective), razor (noun), stimulant (noun), dangerously (adverb), brilliantly (adverb), bully (verb)
In the case of this example, adverb words tend to be ranked in more difficult (less familiar) ranks because adverbs appear less frequently than other parts of speech. For example, in B2 level words, the adverbs “dangerously” and “brilliantly” are ranked later than the nouns “fortnight” and “botany”, but for many people, “dangerously” and “brilliantly” will feel more familiar than “fortnight” and “botany”.

(3) An example in which only the words that appear in the CEFR-J Wordlist are used, and each word is further ranked to have the order of the frequency of appearance of each word in the corpus within each level for each part of speech

Verbs only: [A1] get, [A2]feel, learn, teach, [B1] hurt, swim, provide, cross, avoid, train, snow, worry, hate, pursue, publish, steal, wander, pronounce, experience, [B2] soil, estimate, please, warm, involve, promote, defeat, engage, excuse, emerge, rid, derive, strengthen, persuade, assign, dig, interrupt, grab, thirst, classify, riddle, illuminate, drown, mourn, influence, experiment, row, exhibit, substitute, convert, decay

Nouns only: [A1] minute, [A2]train, sheep, math, mommy, statement, [B1]male, ray, creature, shade, chin, balloon, playground, term, presence, aid, absence, infection, fifth, radiation, confusion, courage, tragedy, guilt, devotion, orbit, elbow, flock, theft, sadness, niece, sunrise, glide, chuckle, [B2]assembly, obligation, stability, dose, throat, holder, midst, query, strand, bankruptcy, correspondent, insult, interruption, hesitation, astronomy, chemotherapy

Adverbs only: [A1] much, [B1]yet, usually, [A2] straight, [B2]far, across, forward, widely, mostly, roughly, worldwide, loudly, merely, forth, naturally, rarely, shortly, definitely, annually, extensively, aboard, evenly, anyhow, pleasantly, previously, practically, presumably, independently, promptly, morally, eagerly, eastward, admittedly, thirdly, powerfully, suitably, tremendously, overboard, stubbornly
As a result, it is possible to rank words by part of speech in the order of the familiarity.

Hereinafter, the configuration of the present embodiment will be described in detail. As illustrated in FIG. 1, a vocabulary size estimation apparatus 5 according to the present embodiment includes a storage unit 51, a question generation unit 52, a presentation unit 53, an answer reception unit 54, and a vocabulary size estimation unit 55.

### Storage Unit 51

The difference between the storage unit 51 and the above-mentioned storage units 11, 21, 31 is only that a DB in which the above-mentioned potential vocabulary size x(m) is associated with each word ω(m) (m=1, . . . , M) of M words ω(1), . . . , ω(M) having the same part of speech is stored in the storage unit 51. A DB for only one part of speech may be stored in the storage unit 51, or a DB for each of the plurality of parts of speech may be stored in the storage unit 51. That is, a potential vocabulary size x(m) of the DB is obtained, for example, based on the frequency of appearance of a word w(m) in the corpus and the part of speech of the word.

### Question Generation Unit 52

When the question generation unit 52 receives the question generation request from the user or the system, the question generation unit 52 selects and outputs a plurality of test words w(1), . . . , w(N) used for the vocabulary size estimation test from the M words ω(1), . . . , ω(M) having the same part of speech included in the DB of the storage unit 51. That is, the question generation unit 52 selects and outputs N test words w(1), . . . , w(N) having the same part of speech. The question generation unit 52 may select and output only the test words w(1), . . . , w(N) of a certain part of speech, or may select and output N test words w(1), . . . , w(N) having the same part of speech for each of the plurality of parts of speech. As mentioned above, in a case where a plurality of parts of speech are assumed for a test word w(n), among the parts of speech of the test word w(n), the part of speech that is most familiar as the part of speech of the test word w(n), or that is most commonly used, or that is learned as the part of speech of the word at the earliest stage of learning is regarded as the part of speech of the test word w(n). Others are the same as those in any of the question generation units 12, 22, and 32 according to the first, second, and third embodiments (step S52).

### Presentation Unit 53, Answer Reception Unit 54

The N test words w(1), . . . , w(N) having the same part of speech output from the question generation unit 52 are input to the presentation unit 53. The presentation unit 13 presents the instruction sentences and the test words w(1), . . . , w(N) having the same part of speech to the user 100 according to a preset display format. In a case where only the test words w(1), . . . , w(N) of a certain part of speech are input to the presentation unit 53, the presentation unit 13 displays the instruction sentences and the test words w(1), . . . , w(N) of the part of speech according to a preset display format. In a case where N test words w(1), . . . , w(N) having the same part of speech are input to the presentation unit 53 for each of the plurality of parts of speech, the presentation unit 13 presents the instruction sentences and N test words w(1), . . . , w(N) having the same part of speech according to a preset display format. The N test words w(1), . . . , w(N) having the same part of speech may be presented divided by each part of speech, or N test words w(1), . . . , w(N) of the part of speech selected by the user 100 may be presented (step S53). The user 100 presented with the instruction sentences and the test words w(1), . . . , w(N) input the answers regarding the knowledge of the test words of the user 100 to the answer reception unit 54. The answer reception unit 54 outputs the answers regarding the knowledge of the input test words (step S54).

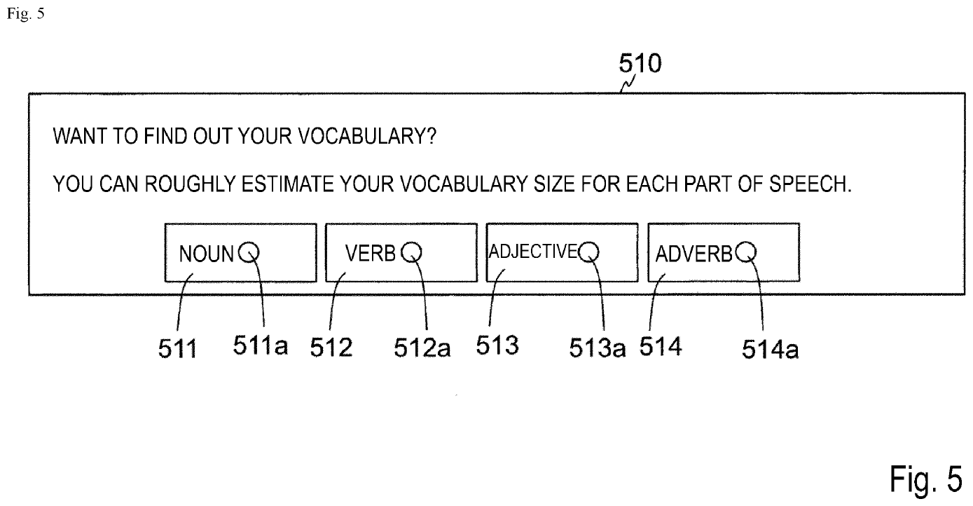

The contents of the presentation from the presentation unit 53 will be illustrated below. First, the presentation unit 53 displays a screen 510 as illustrated in FIG. 5. For example, on the screen 510, an instruction sentence “Please select words you know” and buttons 511, 512, 513, and 514 corresponding to each part of speech (noun, verb, adjective, and adverb) for selecting a part of speech are displayed. For example, the buttons 511, 512, 513, and 514 are provided with display units 511a, 512a, 513a, and 514a indicating to be selected. When the user 100 clicks or taps any of the buttons 511, 512, 513, and 514 of part of speech to select it, a mark is displayed on the display unit of the selected button. For example, in a case where the user 100 selects the button 511 (in a case where noun is selected), a mark is displayed on the display unit 511a.

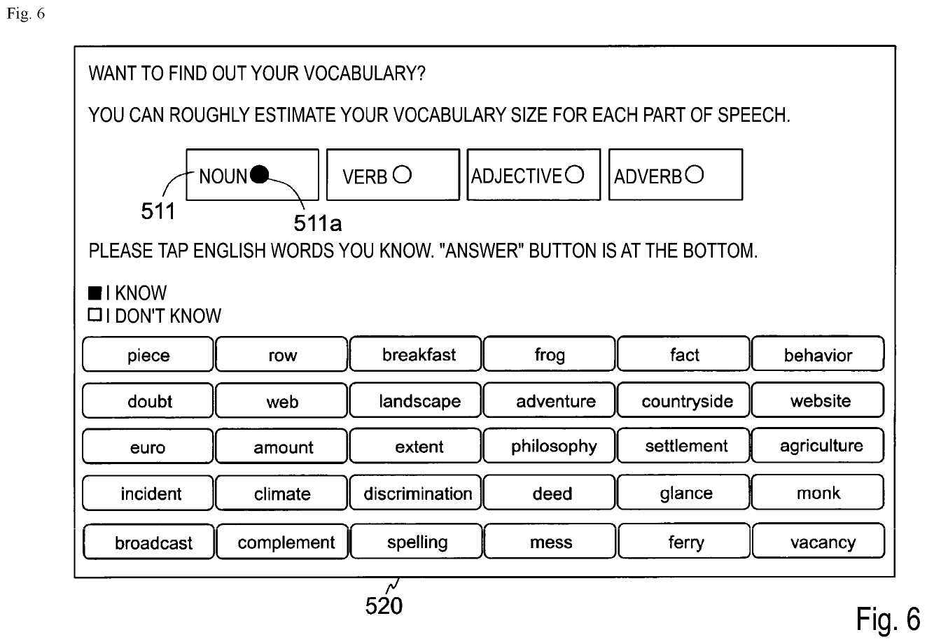

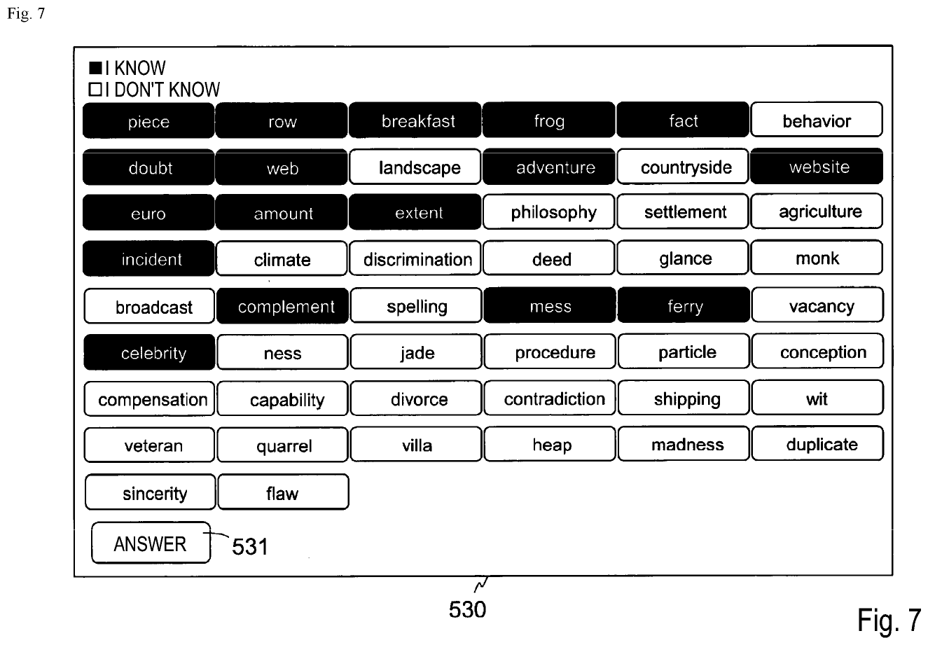

When the part of speech is selected in this way, for example, the presentation unit 53 displays the screen 520 of FIG. 6. On the screen 520, in addition to the display contents of the screen 510, the contents prompting the answer “Please tap English words you know. The “Answer” button is at the bottom”, “I know”, and “I don't know”, and N test words w(1), . . . , w(N) of the selected part of speech are displayed. The user 100 answers by clicking or tapping known test words, for example. However, this is just an example, a function (“Select all”, “Deselect all”, and the like) that allows selection of all test words w(1), . . . , w(N) may be added to the screen, and after the user 100 selects all of the test words w(1), . . . , w(N) by using this function, unknown words may be removed from the selection by tapping or the like. As illustrated in FIG. 7, the color of the portions of the selected test words changes to indicate that the test words have been selected. In a case where the user 100 determines that all the test words the user knows have been selected from the displayed N test words w(1), . . . , w(N), the user 100 clicks or taps the answer button 531. As a result, the answer reception unit 14 outputs answers regarding the knowledge of the N test words w(1), . . . , w(N).

### Vocabulary Size Estimation Unit 55

The answers regarding the knowledge of the test words w(n) of the user 100 output from the answer reception unit 54 are input to the vocabulary size estimation unit 55. The vocabulary size estimation unit 55 executes the process of step S151 described above.

The test words w(1), . . . , w(N) output from the question generation unit 52 are further input to the vocabulary size estimation unit 55. The vocabulary size estimation unit 55 uses the DB stored in the storage unit 51 to obtain the potential vocabulary size x(n) of each test word w(n), and obtains a table [W, X] in which the familiarity order word sequence W having the test words w(1), . . . , w(N) ranked and the potential vocabulary sequence X having the potential vocabulary sizes x(1), . . . , x(N) ranked are associated with each other as described above (step S552).

Furthermore, the vocabulary size estimation unit 55 executes the process of step S153 described above to obtain a table [W′, X] in which the test word sequence W′, which is the sequence of the test words w′(1), . . . , w′(N), and the potential vocabulary sequence X, which is the sequence of the potential vocabulary sizes x(1), . . . , x(N), are associated with each other.

The vocabulary size estimation unit 55 executes the process of step S154 described above, to obtain a model φ by using the set (w′(n), x(n)) of the test word w′(n) and the potential vocabulary size x(n) of each rank n=1, . . . , N extracted from the test words w′(1), . . . , w′(N) of the test word sequence W′ and the potential vocabulary sizes x(1), . . . , x(N) of the potential vocabulary sequence X, and the answers regarding the knowledge of the test words of the user 100.

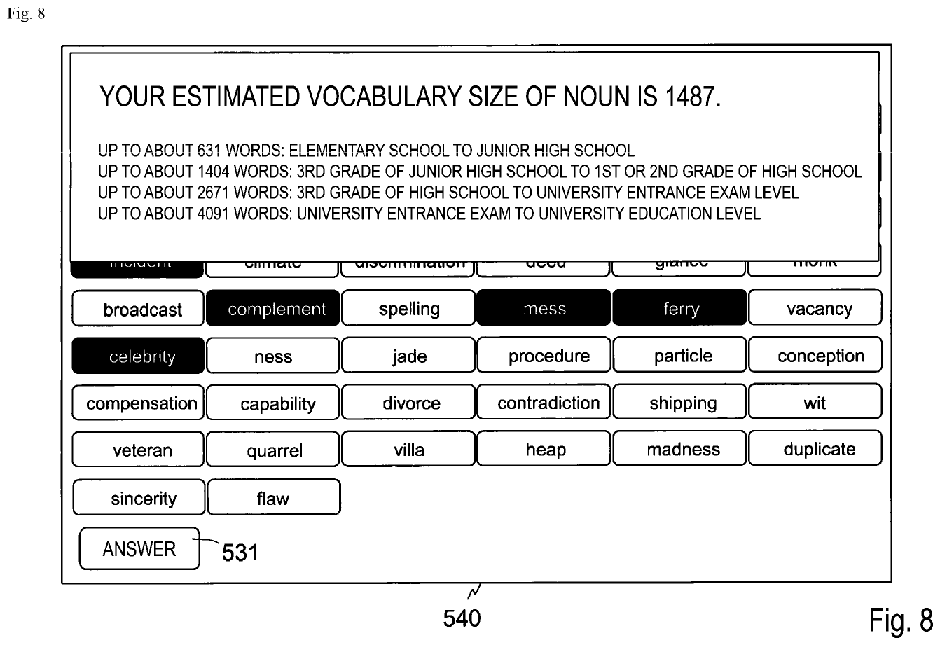

The vocabulary size estimation unit 55 executes the process of step S155 described above, and outputs a value based on a value based on the vocabulary size when the value based on the probability that the user 100 answers that the user knows the words is a predetermined value or in the vicinity of the predetermined value in the model φ as the estimated vocabulary size of the user 100. The output estimated vocabulary size of the user 100 is displayed as illustrated in FIG. 8, for example. In the example of FIG. 8, “Your estimated vocabulary size of noun is 1487”, “Up to about 631 words: elementary school to junior high school”, “Up to about 1404 words: 3rd grade of junior high school to 1st or 2nd grade of high school”, “Up to about 2671 words: 3rd grade of high school to university entrance exam level”, and “Up to about 4091 words: university entrance exam to university education level” are displayed on the screen 540.

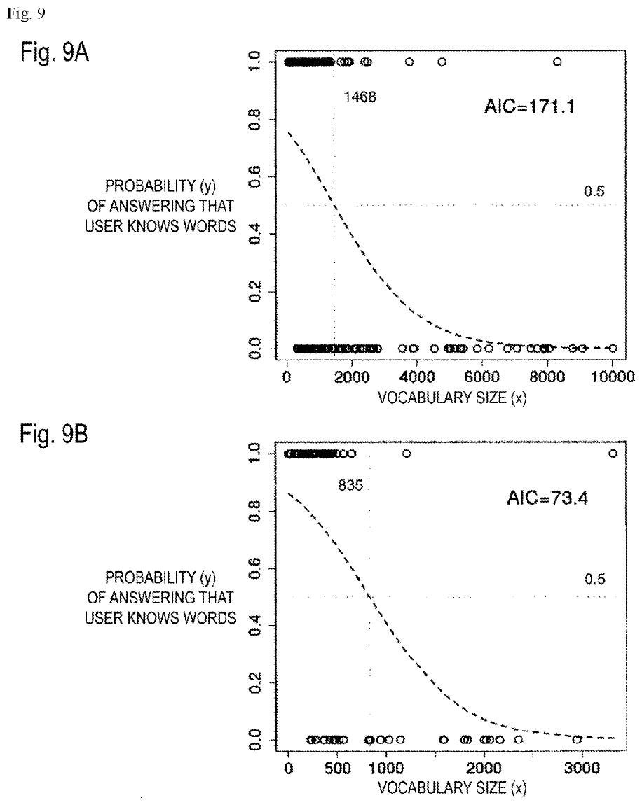

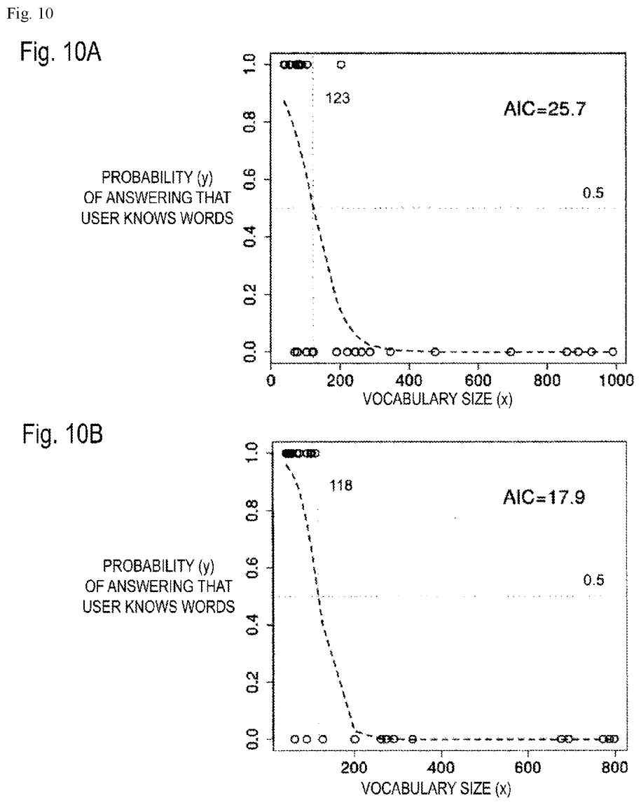

FIG. 9A illustrates the model φ of the logistic curve y=f(x, Ψ) when the vocabulary size estimation is performed without separating words for each part of speech. FIGS. 9B, 10A, and 10B illustrate the model φ of the logistic curve y=f(x, Ψ) when the vocabulary size estimation is performed for each part of speech. The horizontal axis represents the vocabulary size (x), and the vertical axis represents the probability (y) of answering that the user knows words. The circles represent points (x, y)=(x(n), 1) for the test words w′(n) that the user 100 answered that the user knew, and points (x, y)=(x(n), 0) for the test words w′(n) that the user 100 answered that the user did not know (or did not answer that the user knew). In FIG. 9A, AIC=171.1, whereas in FIG. 9B, AIC=73.4, and in FIG. 10A, AIC=25.7, whereas in FIG. 10B, AIC=17.9. From these, compared to the case where the vocabulary size estimation is performed without separating words for each part of speech, it can be seen that the AIC is smaller when the vocabulary size estimation is performed for each part of speech, and the model tends to fit better than the one in which the condition is not completely matched.

### Modification of Fifth Embodiment

Even a word with a relatively low frequency of appearance may not be a difficult word if it is considered as a derived form of a commonly used word. For example, in terms of the levels of difficulty of CEFR-J Wordlist, the level of understand (verb) is A2, while the levels of its derived forms: understandable (adjective), understanding (adjective), and understanding (noun), are B2. That is, a higher level of difficulty is given to understandable (adjective), understanding (adjective), and understanding (noun) than understand (verb).

+−−−−−−−−−−−−−−−−+−−−−−−−−−−−+−−−−−−+
| WORD | POS | CEFR |
+−−−−−−−−−−−−−−−−+−−−−−−−−−−−+−−−−−−+
| understand | verb | A2 |
| understandable | adjective | B2 |
| understanding | adjective | B2 |
| understanding | noun | B2 |
+−−−−−−−−−−−−−−−−+−−−−−−−−−−−+−−−−−−+

Words with prefixes such as in-, re-, and un- are often relatively well-known words without the prefixes. For example, inexperienced has a low frequency of appearance, so when it is ranked by frequency of appearance, the rank will be low (a word that is unfamiliar), but experience is a word that has a high frequency of appearance and is a relatively well known word. Even in terms of the levels of difficulty of CEFR-J Wordlist, the level of inexperienced (adjective) is B2, but the level of experience (noun) is A2, and a higher level of difficulty is given than experience. Thus, words of derived forms and/or words with prefixes may be excluded from the DB or the test word candidates.

English words that are in Katakana words (a type of Japanese character) in Japanese (hereinafter referred to as “words that are in Katakana words”) are likely to be well known to Japanese people. For example, button, rabbit, and the like are words that are well known to Japanese people. For such words, the familiarity for Japanese people deviates from the familiarity based on the frequency of appearance of each word in the corpus or the familiarity of native English speakers. Thus, if words that are in Katakana words are used as the test words, the vocabulary size may be estimated higher than the actual vocabulary size. Thus, it is desirable not to use words that are in Katakana words as the test words. Whether or not a word is in a Katakana word can be inferred from a Japanese-English dictionary. For example, by determining whether or not the Japanese translation of a word is a Katakana word in a Japanese-English dictionary, it is possible to infer whether or not the word is in a Katakana word. Instead of excluding all words that are in Katakana words from the test word candidates, only in a case where the familiarity of the Katakana words for Japanese people exceeds a threshold value among the words that are in Katakana words (in a case where the familiarity is high), the words that are in Katakana words may be excluded from the test word candidates. For example, impedance is a word that is in a Katakana word, but the familiarity of “impedance” for Japanese people is as low as 2.5, and it is considered that impedance is not a word that everyone knows, so that impedance may be selected as a test word. On the other hand, the familiarities of “rabbit” and “button” for Japanese people are 6 or greater, and it can be inferred that such words are generally well-known words, so that button and rabbit are not selected as test words.

Roman numerals (for example, xiv) and words of two to three letters or less may be excluded from the DB or the test word candidates. In particular, this is because the frequencies of appearance of symbols such as a. . . . b. . . . c. . . . or words in languages other than English (French) that appear in English sentences (for example, la, de) may be counted, and the familiarities of words may not be evaluated correctly, in a case where the “predetermined ranking criteria” are criteria for ranking each word to have the order of the frequency of appearance of each word in the corpus.

The vocabulary size estimation unit 55 may output the total estimated vocabulary size obtained by summing up the estimated vocabulary sizes after obtaining the estimated vocabulary size for each part of speech. Alternatively, the vocabulary size estimation unit 55 may obtain an estimated vocabulary size for a certain part of speech and then obtain an estimated vocabulary size for another part of speech from the estimated vocabulary size for that part of speech and output it.

In the present embodiment, the vocabulary size estimation unit 55 executes the process of step S153 described above to rearrange the test words to obtain a table [W′, X], and obtains a model φ by using the set (w′(n), x(n)) extracted from the table [W′, X] and the answers regarding the knowledge of the test words of the user 100. However, the model φ may be obtained without rearranging the test words. That is, the vocabulary size estimation unit 55 may obtain the model φ by using a set (w(n), x(n)) of a test word w(n) and a potential vocabulary size x(n) of each rank n=1, . . . , N extracted from the test words w(1), . . . , w(N) of the test word sequence W and the potential vocabulary sizes x(1), . . . , x(N) of the potential vocabulary sequence X of the table [W, X], and the answers regarding the knowledge of the test word of the user 100. A specific example of this process is as described in the first embodiment, except that w′(n) is replaced with w(n). Note that, in this case, the processes of steps S151 and S153 are omitted.

In the present embodiment, an example of estimating the vocabulary size of English words of the user 100 who is a Japanese person has been illustrated. However, the present invention is not limited to this, and vocabulary sizes of non-native words of users 100 of other nationalities may be estimated. That is, the present embodiment may be carried out in a form in which “Japanese people” is replaced with “arbitrary citizens”, “Japanese” is replaced with “native language”, and “English” is replaced with “non-native language” in the description of the present embodiment. Alternatively, in the present embodiment, vocabulary sizes of Japanese words of users 100 who are Japanese people may be estimated. That is, the present embodiment may be carried out in a form in which “English” is replaced with “Japanese”. Further, in the present embodiment, the vocabulary size in the native language of users 100 of other nationalities may be estimated. That is, the present embodiment may be carried out in a form in which “Japanese people” is replaced with “arbitrary citizens”, and “Japanese” and “English” are replaced with “native language” in the description of the present embodiment.

As described above, the fifth embodiment may be applied to the second embodiment, the modification thereof, or the third embodiment. That is, in the fifth embodiment, as described in the second embodiment and the modification thereof, the test words may be selected from words other than the words characteristic of the text in the specific fields. In the fifth embodiment, as described in the third embodiment, words whose degrees of adequacy of the notations meet the predetermined criteria may be selected as the test words.

In the fifth embodiment, the storage unit 51 stores the DB in which a set of a plurality of words and the potential vocabulary size obtained for each of the words are associated with each other. However, instead of this, as described above, the storage unit 51 may store the DB storing at least any one of the frequencies of appearance, the parts of speech, and the foreign language familiarities of the words for obtaining the potential vocabulary size of each word. In this case, the vocabulary size estimation unit 55 uses the DB to obtain the potential vocabulary size x(n) of each test word w(n), and obtains a table [W, X] in which the familiarity order word sequence W having the test words w(1), . . . , w(N) ranked and the potential vocabulary sequence X having the potential vocabulary sizes x(1), . . . , x(N) ranked are associated with each other as described above (step S552).

### Sixth Embodiment

The sixth embodiment is a modification for the first to fifth embodiments and a modification for the modification of the first embodiment, and differs from these in that the vocabulary acquisition curve representing the vocabulary acquisition ratio in each grade or each age is obtained for each word from the answers regarding the knowledge of the test words of the plurality of users 100.

In the first to fifth embodiments and the modification of the first embodiment, the vocabulary size estimation of each user is performed. In the sixth embodiment, a vocabulary acquisition curve representing the vocabulary acquisition ratio in each generation is obtained from the answers regarding the knowledge of the test words of the plurality of users 100 and the grades or the ages of the users. Hereinafter, a detailed description will be given.

As illustrated in FIG. 1, a vocabulary size estimation apparatus 6 according to the present embodiment is obtained by adding a vocabulary acquisition curve calculation unit 66 and a storage unit 67 for storing a vocabulary acquisition curve DB to the vocabulary size estimation apparatus 5 according to any one of the first to fifth embodiments or the modification of the first embodiment. In the following, only the vocabulary acquisition curve calculation unit 66 and the storage unit 67 will be described.

### Vocabulary Acquisition Curve Calculation Unit 66

Input: Answers regarding the knowledge of the test words of a plurality of users (for a plurality of grades or a plurality of ages)
Output: Vocabulary acquisition curve for each word
Answers regarding the knowledge of the test words of the plurality of users 100 output from the answer reception unit 14 or 54 are input to the vocabulary acquisition curve calculation unit 66. These answers are obtained by presenting the same N test words w(1), . . . , w(N) from the presentation unit 13 or 54 as described above to the users 100 of a plurality of grades or ages g(1), . . . , g(J). Here, J is an integer of 2 or greater, and j=1, . . . , J. In the present embodiment, it is assumed that information of the grades or the ages of the users 100 is input to the vocabulary acquisition curve calculation unit 66 as well as the answers regarding the knowledge of the test words of the plurality of users 100. The vocabulary acquisition curve calculation unit 66 uses the answers and information of the grades or the ages of the users 100 who made the answers to obtain the acquisition ratio r(j, n) of each test word w(n) in each grade or age g(j) for each test word w(n) (where, n=1, . . . , N) (step S661).

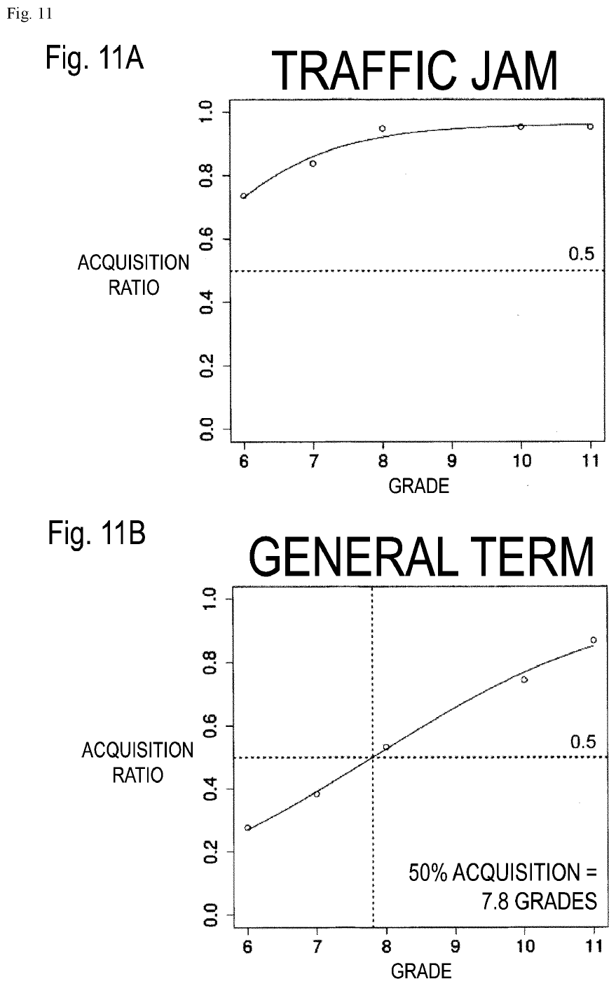

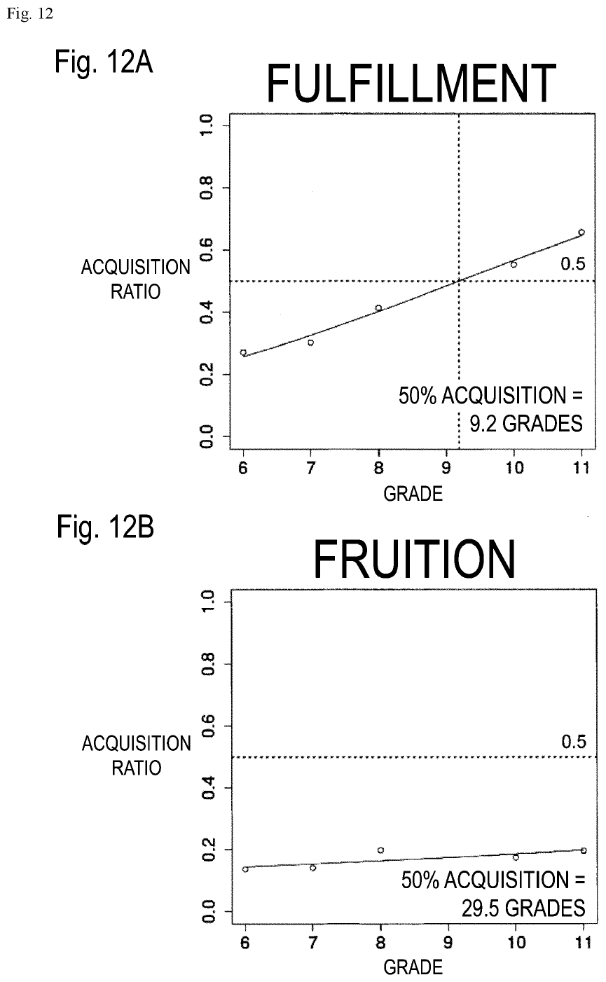

Further, the vocabulary acquisition curve calculation unit 66 uses the acquisition ratio r(j, n) of each test word w(n) in each grade or age g(j) to obtain a vocabulary acquisition curve r(n)=H(w(n), Θ′(n)) which is an approximate for obtaining the acquisition ratio r(n) of the test word w(n) with respect to each grade or age g for each test word w(n), and outputs information for specifying the vocabulary acquisition curve r(n)=H(w(n), Θ′(n)) to the storage unit 67. The vocabulary acquisition curve r(n)=H(w(n), Θ′(n)) is, for example, a logistic curve obtained by logistic regression. The information for specifying the vocabulary acquisition curve r(n)=H(w(n), Θ′(n)) may be a set of the test word w(n) and the model parameter Θ′(n), may be waveform data of the vocabulary acquisition curve r(n)=H(w(n), Θ′(n)), may be other information for specifying the vocabulary acquisition curve r(n), or may be a combination of these. The storage unit 67 stores the information for specifying the N vocabulary acquisition curves r(1), . . . , r(N) obtained for the test words w(1), . . . , w(N) as the vocabulary acquisition curve DB. FIGS. 11A, 11B, 12A, and 12B illustrate the vocabulary acquisition curves of the test words “traffic jam”, “general term”, “fulfillment”, and “fruition”. The horizontal axis of these figures indicates the grade, and the vertical axis indicates the acquisition ratio. Note that, on the horizontal axis of these figures, grades 1 to 6 are referred to as grades 1 to 6, grades 1 to 3 of junior high school are referred to as grades 7 to 9, and grades 1 to 3 of high school are referred to as grades 10 to 12. The circles represent the acquisition ratio r(j, n) of each test word w(n) in each grade or age g(j) obtained in step S661. In these examples, it is estimated that the grade in which 50% of people acquire “general term” is 7.8 grades, it is estimated that the grade in which 50% of people acquire “fulfillment” is 9.2 grades, and it is estimated that the grade in which 50% of people acquire “fruition” is 29.5 grades (step S662). In a case where the grade in which the vocabulary is acquired is a value expressed in decimals, the integer value can be regarded as the grade, and the decimal value can be regarded as the period when the year is divided into ten. For example, if the grade for acquisition is 7.8 grades, it is estimated that the vocabulary will be acquired in the latter half of the first year of junior high school. The grade in which the vocabulary is acquired may be a value exceeding 12. In this case, for example, the value χ+12 obtained by adding the elapsed years χ starting from April of the high school graduation year to 12 is defined as the grade. For example, the 29th grade is 35 years old. In this case as well, the grade may be expressed as a decimal as described above.

### Modification of Sixth Embodiment

In the sixth embodiment, the answers regarding the knowledge of the test words of the plurality of users 100 output from the answer reception unit 14 or 54 in the process of the vocabulary size estimation in the first to fifth embodiments or the modification of the first embodiment, and the information of the grades or the ages of the users 100 are input to the vocabulary acquisition curve calculation unit 66, and the vocabulary acquisition curve calculation unit 66 performs the vocabulary size estimation. However, answers regarding the knowledge of the same word by users of a plurality of grades or ages (for example, answers whether or not the users know the words) and information of the grades or the ages of the users obtained in other than the above-mentioned vocabulary size estimation process may be input to the vocabulary acquisition curve calculation unit 66, and the vocabulary acquisition curve calculation unit 66 may use these to obtain a vocabulary acquisition curve.

For example, the answers regarding the knowledge of the same word may be obtained by a survey of whether or not the word is known for a purpose other than vocabulary estimation, or may be results of “Kanji tests” or “Kanji reading tests”. That is, any answer may be used as long as it is an answer regarding the knowledge of the word obtained by surveying for the same word in a plurality of grades (ages).

As illustrated in FIG. 1, the vocabulary size estimation apparatus 6 may further include an acquisition grade estimation unit 68.

### Acquisition Grade Estimation Unit 68

Input: Word in a case where the acquisition ratio of the specific word (vocabulary) for each grade or age is required (Case 1), word and grade or age in a case where the acquisition ratio of the specific grade or age is required (Case 2)
Output: Vocabulary acquisition curve of the input word in Case 1, acquisition ratio of the input word in the input grade or age in Case 2

In the case of Case 1, the target word is input to the acquisition grade estimation unit 68. The acquisition grade estimation unit 68 extracts information for specifying the vocabulary acquisition curve r(n)=H(w(n), Θ′(n)) of the word w(n) matching the input word from the vocabulary acquisition curve DB of the storage unit 67, and outputs the vocabulary acquisition curve r(n)=H(w(n), Θ′(n)).

In the case of Case 2, the target word and the target grade or age are input to the acquisition grade estimation unit 68. The acquisition grade estimation unit 68 extracts information for specifying the vocabulary acquisition curve r(n)=H(w(n), Θ′(n)) of the word w(n) matching the input word from the vocabulary acquisition curve DB of the storage unit 67. Further, the acquisition grade estimation unit 68 obtains and outputs the acquisition ratio in the target grade or age in the vocabulary acquisition curve r(n)=H(w(n), Θ′(n)).

Note that the target grade or age may be the acquisition ratio in a grade or age other than the grades or the ages of the users who made the answers input to the vocabulary acquisition curve calculation unit 66 in order to obtain the vocabulary acquisition curve in steps S661 and S662. For example, the acquisition ratio r(j, n) corresponding to the grade g(j)=9 (3rd grade of junior high school) is not used in order to obtain the vocabulary acquisition curves of FIGS. 11A, 11B, 12A, and 12B, but the acquisition grade estimation unit 68 can also obtain the acquisition ratio in the grade 9.

Further, in Cases 1 and 2, the acquisition grade estimation unit 68 may further obtain and output the grade or age at which 50% of the people acquires the target word.

### Hardware Configuration

The vocabulary size estimation apparatus 1 to 6 in each embodiment is, for example, an apparatus configured by a general-purpose or dedicated computer including a processor (a hardware processor) such as a central processing unit (CPU), a memory such as a random-access memory (RAM) and a read-only memory (ROM), and the like executing a predetermined program. The computer may include a single processor or memory, or may include a plurality of processors and memories. The program may be installed on the computer or may be previously recorded in a ROM or the like. Some or all of processing units may be configured using an electronic circuit that implements processing functions alone rather than an electronic circuit (circuitry) such as a CPU that implements a functional configuration by reading a program. An electronic circuit constituting one apparatus may include a plurality of CPUs.

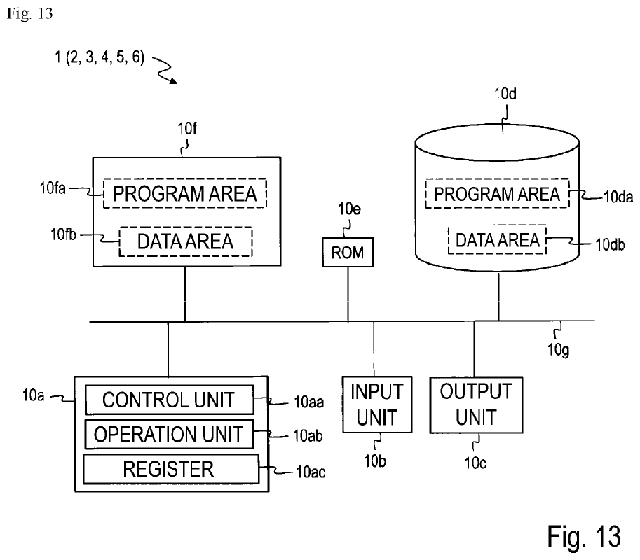

FIG. 13 is a block diagram illustrating a hardware configuration of the vocabulary size estimation apparatus 1 to 6 in each embodiment. As illustrated in FIG. 13, the vocabulary size estimation apparatus 1 to 6 of this example includes a Central Processing Unit (CPU) 10a, an input unit 10b, an output unit 10c, a Random Access Memory (RAM) 10d, a Read Only Memory (ROM) 10e, an auxiliary storage device 10f, and a bus 10g. The CPU 10a of this example has a control unit 10aa, an operation unit 10ab, and a register 10ac, and executes various arithmetic processing in accordance with various programs read into the register 10ac. The input unit 10b is an input terminal, a keyboard, a mouse, a touch panel, or the like via which data is input. The output unit 10c is an output terminal, a display, a LAN card or the like that is controlled by the CPU 10a loaded with a predetermined program, or the like via which data is output. The RAM 10d is a Static Random Access Memory (SRAM), a Dynamic Random Access Memory (DRAM), and the like, and has a program area 10da in which a predetermined program is stored and a data area 10db in which various types of data are stored. The auxiliary storage device 10f is, for example, a hard disk, a Magneto-Optical (MO) disc, a semiconductor memory, and the like, and includes a program area 10fa in which a predetermined program is stored and a data area 10fb in which various types of data are stored. The bus 10g connects the CPU 10a, the input unit 10b, the output unit 10c, the RAM 10d, the ROM 10e, and the auxiliary storage device 10f with one another to enable information to be exchanged. The CPU 10a writes a program stored in the program area 10fa of the auxiliary storage device 10f to the program area 10da of the RAM 10d in accordance with a read Operating System (OS) program. Similarly, the CPU 10a writes various data stored in the data area 10fb of the auxiliary storage device 10f to the data area 10db of the RAM 10d. Then, the addresses on the RAM 10d to which this program or data has been written are stored in the register 10ac of the CPU 10a. The control unit 10aa of the CPU 10a sequentially reads these addresses stored in the register 10ac, reads the program and data from the area on the RAM 10d indicated by the read addresses, causes the operation unit 10ab to perform operations indicated by the program, and stores the calculation results in the register 10ac. With such a configuration, the functional configuration of the vocabulary size estimation apparatus 1 to 6 is implemented.

The above-described program can be recorded on a computer-readable recording medium. An example of the computer-readable recording medium is a non-transitory recording medium. Examples of such a recording medium include a magnetic recording device, an optical disc, a magneto-optical recording medium, or a semiconductor memory.

The program is distributed, for example, by selling, transferring, or lending a portable recording medium such as a DVD or a CD-ROM with the program recorded on it. Further, the program may be stored in a storage device of a server computer and transmitted from the server computer to another computer via a network, so that the program is distributed. For example, a computer that executes such a program first temporarily stores the program recorded on the portable recording medium or the program forwarded from the server computer in its own storage device. When executing the processing, the computer reads the program stored in its own storage device and executes the processing in accordance with the read program. As another execution form of this program, the computer may directly read the program from the portable recording medium and execute processing in accordance with the program, or, further, may sequentially execute the processing in accordance with the received program each time the program is transferred from the server computer to the computer. It can also be configured to execute the processing described above through a so-called Application Service Provider (ASP) type service in which processing functions are implemented just by issuing an instruction to execute the program and obtaining results without transmitting the program from the server computer to the computer. Note that the program in this form is assumed to include information which is provided for processing of a computer and is equivalent to a program (data or the like that has characteristics of defining the processing of the computer rather than being a direct instruction to the computer).

In each embodiment, although the present apparatus is configured by executing a predetermined program on a computer, at least a part of the processing details may be implemented by hardware.

Note that the present invention is not limited to the above-described embodiment. For example, the various processing operations described above may be executed not only in chronological order as described but also in parallel or on an individual basis as necessary or depending on the processing capabilities of the apparatuses that execute the processing operations. Further, it is needless to say that the present invention can appropriately be modified without departing from the gist of the present invention.

### REFERENCE SIGNS LIST

1 to 6 Vocabulary size estimation apparatus
12, 22, 32, 52 Question generation unit
13, 53 Presentation unit
14, 54 Answer reception unit
15, 45, 55 Vocabulary size estimation unit

1. A vocabulary size estimation apparatus comprising a processor configured to execute a method comprising:
selecting a plurality of test words from a plurality of words;
presenting the plurality of test words to a user;
receiving an answer regarding knowledge of the plurality of test words of the user; and
obtaining a model representing a relationship between a value based on a probability that the user answers that the user knows the plurality of words and a value based on a vocabulary size of the user when the user answers that the user knows the plurality of words, using a combination including the plurality of test words, estimated vocabulary sizes of persons who know the plurality of test words, and the answer regarding the knowledge of the plurality of test words,
wherein
the obtaining further comprises obtaining the estimated vocabulary sizes based on frequencies of appearance of the plurality of words in a corpus and parts of speech of the plurality of words.

2. The vocabulary size estimation apparatus according to claim 1, wherein
the estimated vocabulary sizes are determined for each of the parts of speech of the plurality of test words, and
an estimated vocabulary size of the estimated vocabulary sizes of a person of the persons who knows a first test word of a specific part of speech whose frequency of appearance is a first value is less than an estimated vocabulary size of the estimated vocabulary sizes of a person of the persons who knows a second test word of the specific part of speech whose frequency of appearance is a second value, the plurality of test words include the first test word and the second test word, and the first value is larger than the second value.

3. The vocabulary size estimation apparatus according to claim 2, wherein
the specific part of speech corresponds to a part of speech most familiar as a part of speech of the first test word or the second test word among a part of speech of the first test word or a part of speech of the second test word.

4. The vocabulary size estimation apparatus according to any one of claim 1, wherein
a language of the plurality of words corresponds to a non-native language.

5. The vocabulary size estimation apparatus according to any one of claim 1, wherein
the obtaining uses a rank-by-rank set, extracted from a test word sequence having, as elements, a plurality of test words selected from a plurality of words ranked and a potential vocabulary sequence having, as elements, a plurality of potential vocabulary sizes ranked, of the plurality of test words and the plurality of potential vocabulary sizes, and the answer regarding the knowledge of the plurality of test words to obtain the model,
the plurality of test words is ranked to have order based on familiarity within subjects to the plurality of test words of the subjects belonging to a specific subject set, and
the plurality of potential vocabulary sizes correspond to the plurality of test words, are estimated based on the familiarity predetermined for the plurality of words, and are ranked to have order based on the familiarity.

6. The vocabulary size estimation apparatus according to claim 5, wherein
the obtaining further comprises rearranging, in order based on the familiarity within the subjects, the plurality of test words included in a familiarity order word sequence where the plurality of test words are ranked to have order based on the familiarity to obtain the test word sequence.

7. The vocabulary size estimation apparatus according to claim 1, wherein
the obtaining further comprises outputting a value based on the vocabulary size when, in the model, the value based on the probability that the user answers that the user knows the plurality of words is a predetermined value or is in a vicinity of the predetermined value, as an estimated vocabulary size of the user.

8. A computer implemented method for estimating a vocabulary size, comprising:
selecting a plurality of test words from a plurality of words;
presenting the plurality of test words to a user;
receiving an answer regarding knowledge of the plurality of test words of the user; and
obtaining a model representing a relationship between a value based on a probability that the user answers that the user knows the plurality of words and a value based on a vocabulary size of the user when the user answers that the user knows the plurality of words, using the plurality of test words, estimated vocabulary sizes of persons who know the plurality of test words, and the answer regarding the knowledge of the plurality of test words,
wherein
the obtaining further comprises obtaining the estimated vocabulary sizes based on frequencies of appearance of the plurality of words in a corpus and parts of speech of the plurality of words.

9. A computer-readable non-transitory recording medium storing computer-executable program instructions that when executed by a processor cause a computer to execute a method comprising:
selecting a plurality of test words from a plurality of words;
presenting the plurality of test words to a user;
receiving an answer regarding knowledge of the plurality of test words of the user; and
obtaining a model representing a relationship between a value based on a probability that the user answers that the user knows the plurality of words and a value based on a vocabulary size of the user when the user answers that the user knows the plurality of words, using the plurality of test words, estimated vocabulary sizes of persons who know the plurality of test words, and the answer regarding the knowledge of the plurality of test words,
wherein
the obtaining further comprises obtaining the estimated vocabulary sizes based on frequencies of appearance of the plurality of words in a corpus and parts of speech of the plurality of words.

10. The computer implemented method according to claim 8, wherein
the estimated vocabulary sizes are determined for each of the parts of speech of the plurality of test words, and
an estimated vocabulary size of the estimated vocabulary sizes of a person of the persons who knows a first test word of a specific part of speech whose frequency of appearance is a first value is less than an estimated vocabulary size of the estimated vocabulary sizes of a person of the persons who knows a second test word of the specific part of speech whose frequency of appearance is a second value, the plurality of test words include the first test word and the second test word, and the first value is larger than the second value.

11. The computer implemented method according to claim 10, wherein
the specific part of speech corresponds to a part of speech most familiar as a part of speech of the first test word or the second test word among a part of speech of the first test word or a part of speech of the second test word.

12. The computer implemented method according to claim 8, wherein
a language of the plurality of words corresponds to a non-native language.

13. The computer implemented method according to claim 8, wherein
the obtaining uses a rank-by-rank set, extracted from a test word sequence having, as elements, a plurality of test words selected from a plurality of words ranked and a potential vocabulary sequence having, as elements, a plurality of potential vocabulary sizes ranked, of the plurality of test words and the plurality of potential vocabulary sizes, and the answer regarding the knowledge of the plurality of test words to obtain the model,
the plurality of test words is ranked to have order based on familiarity within subjects to the plurality of test words of the subjects belonging to a specific subject set, and
the plurality of potential vocabulary sizes correspond to the plurality of test words, are estimated based on the familiarity predetermined for the plurality of words, and are ranked to have order based on the familiarity.

14. The computer implemented method according to claim 13, wherein
the obtaining further comprises rearranging, in order based on the familiarity within the subjects, the plurality of test words included in a familiarity order word sequence where the plurality of test words are ranked to have order based on the familiarity to obtain the test word sequence.

15. The computer implemented method according to claim 8, wherein
the obtaining further comprises outputting a value based on the vocabulary size when, in the model, the value based on the probability that the user answers that the user knows the plurality of words is a predetermined value or is in a vicinity of the predetermined value, as an estimated vocabulary size of the user.

16. The computer-readable non-transitory recording medium according to claim 9, wherein
the estimated vocabulary sizes are determined for each of the parts of speech of the plurality of test words, and
an estimated vocabulary size of the estimated vocabulary sizes of a person of the persons who knows a first test word of a specific part of speech whose frequency of appearance is a first value is less than an estimated vocabulary size of the estimated vocabulary sizes of a person of the persons who knows a second test word of the specific part of speech whose frequency of appearance is a second value, the plurality of test words include the first test word and the second test word, and the first value is larger than the second value.

17. The computer-readable non-transitory recording medium according to claim 16, wherein
the specific part of speech corresponds to a part of speech most familiar as a part of speech of the first test word or the second test word among a part of speech of the first test word or a part of speech of the second test word.

18. The computer-readable non-transitory recording medium according to claim 9, wherein
a language of the plurality of words corresponds to a non-native language.

19. The computer-readable non-transitory recording medium according to claim 9, wherein
the obtaining uses a rank-by-rank set, extracted from a test word sequence having, as elements, a plurality of test words selected from a plurality of words ranked and a potential vocabulary sequence having, as elements, a plurality of potential vocabulary sizes ranked, of the plurality of test words and the plurality of potential vocabulary sizes, and the answer regarding the knowledge of the plurality of test words to obtain the model,
the plurality of test words is ranked to have order based on familiarity within subjects to the plurality of test words of the subjects belonging to a specific subject set, and
the plurality of potential vocabulary sizes correspond to the plurality of test words, are estimated based on the familiarity predetermined for the plurality of words, and are ranked to have order based on the familiarity.

20. The computer-readable non-transitory recording medium according to claim 19, wherein
the obtaining further comprises rearranging, in order based on the familiarity within the subjects, the plurality of test words included in a familiarity order word sequence where the plurality of test words are ranked to have order based on the familiarity to obtain the test word sequence.
